(19) United States
(12) Patent Application Publication
(10) Pub. No.: US 2016/0023233 A1
(43) Pub. Date: Jan. 28, 2016

(54) Liquid Material Discharge Device

(71) Applicant: PRIMEDOT KABUSHIKI KAISHA, Adachi-ku, Tokyo (JP)

(72) Inventor: Hideki Hayashi, Yokohama-shi (JP)

(21) Appl. No.: 14/761,135

(22) PCT Filed: Jan. 16, 2014
(86) PCT No.: PCT/JP2014/000201

§ 371 Date: Jul. 15, 2015

(30) Foreign Application Priority Data
Jan. 16, 2013 (JP) 2013-005635

(51) Int. Cl. B05C 9/02

(52) U.S. Cl. CPC B05C 9/02

(57) ABSTRACT

A syringe or a functional cartridge inserted with a needle and attached with a valve seat assembly can be removably attached to a valve body by magnetically coupling the needle inserted inside the syringe or the functional cartridge to a driven member inside the valve body.

### TECHNICAL FIELD

The present invention relates to a liquid material discharge device (also referred to as a valve) to discharge a small amount of liquid material such as adhesive agent and silicone resin liquid onto a circuit board with high accuracy in the case of, for example, mounting an electronic component and the like on the circuit board.

### BACKGROUND ART

As a liquid material discharge device to discharge a small amount of liquid material such as adhesive agent and silicone resin liquid, there is a known related art in which the liquid material filled in a small container called a syringe is discharged only for a very short period by attracting a valve stem with a solenoid for the mentioned very short period. The valve stem constitutes a valve in a space with a valve seat (Patent Literature 1).

This liquid material discharge device includes: a frame formed of an upper bracket portion and a lower bracket portion and designed to conform to a maximum syringe size meeting a purpose of use; a body removable from the upper bracket portion of the frame and provided with a threaded portion to attach an actuator at an upper end, and provided with an inserting portion to be inserted into a syringe and an installation portion for an attachment at a lower end; an actuator attached to the threaded portion provided at the upper end of the body; a valve stem operated by the actuator; and a valve seat member set at a tip of the syringe and attached to the lower bracket portion, in which the liquid material filled inside the syringe is discharged by opening and closing, with the actuator, a valve mechanism formed of the valve stem and the valve seat member at the tip of the syringe.

According to this liquid material discharge device, for example, the solenoid is used as the actuator. While the valve stem in which a needle and a disk-shaped armature are integrally formed is magnetically attracted by the solenoid, the valve stem is pushed back to a home position by spring force applied by a spring disposed between the solenoid and the armature, thereby pulling up the valve stem so as to open the valve seat while the solenoid is excited. Here, the solenoid is set vertically movable relative to the body by screwing the solenoid into the thread at the upper end of the body, and a stroke amount of the valve stem can be adjusted by adjusting clearance between the solenoid and armature.

Further, the solenoid (actuator), body, and syringe are mutually connected via the body, and disposed so as to be set between the upper bracket and the lower bracket of the frame in an integrated state as a dispensing mechanism. More specifically, in the state that a needle portion of the valve stem is inserted from an upper opening of the body and passed through the body to make the needle portion project from the inserting portion at the lower end of the body and the armature is housed inside an inner space of the valve, the solenoid, body, and syringe are integrated by screwing the solenoid into the thread at an upper portion of the body and attaching the syringe to the inserting portion of the body while introducing, into the syringe, the needle portion projected from the inserting portion at the lower end of the body. Further, while the valve seat portion at the tip of the syringe is fitted into the lower bracket, a trunk of the body is inserted and fixed between a bifurcated portion of the upper bracket so as to hook a neck portion. Furthermore, a gas hole formed at the upper bracket is made to communicate with a passage hole formed at the body by rotating the body 90 degrees in this state, and a gas to be discharged into the syringe is introduced to apply discharging pressure into the syringe, and at the same time the syringe is moved to a proper position by this pressure.

### CITATION LIST

### Patent Literature

Patent Literature 1: JP 2001-157862 A

### SUMMARY OF INVENTION

### Technical Problem

However, according to the discharge device disclosed in Patent Literature 1, the valve stem formed by integrating the armature portion with the needle portion is inserted such that the armature portion is sandwiched between the body and the actuator, and the integrated actuator, body, and syringe are set between the upper bracket and the lower bracket of a frame body so as to insert, into the syringe, the needle portion passing through the body. Therefore, at the time of changing the syringe to refill the liquid material, the syringe is needed to be changed after removing not only the syringe but also the body and actuator from the upper bracket and the lower bracket of the frame body together with the syringe at the same time. This is no better than disassembling/removing a main component which determines the stroke amount of the valve, and there may be a problem in which readjustment of discharge parameters is necessary and workability is deteriorated because reproducibility of the same discharge is hardly obtained.

Further, according to the invention disclosed in Patent Literature 1, the syringe is moved to the proper position and held at a predetermined position by applying, into the syringe, air pressure at the time of discharging the liquid material filled inside the syringe after the integrated actuator, body, and syringe are set between the upper bracket and the lower bracket of the frame body. However, in the case where the discharging pressure applied to the syringe is low, an O-ring to seal the syringe becomes resistance and there may be a case where the syringe cannot be forcibly pushed downward. This is an unignorable problem because the discharging pressure tends to be decreased (to 0.1 MPa or less, further, to micro pressure such as about 0.01 MPa) due to downsizing of an electric component in recent years. In other words, in the case of discharging/applying a small amount of liquid material under the low discharging pressure, there may be a risk that the syringe cannot be pushed down to the predetermined position due to resistance of the O-ring to seal the syringe, and stroke of the valve stem cannot achieve a proper open level. Moreover, while pressurization is repeated for discharge, an open and close amount/stroke amount of the valve may fluctuate from an initial value and a discharge amount may fluctuate by the syringe being pushed down to the predetermined position. For example, the discharge amount may be increased double or more because the stroke amount initially set is increased by the syringe being pushed down during use. Considering this, discharging a small amount with high accuracy is difficult.

Also, the valve stem formed of the disk-shaped armature portion and the needle portion in the discharge device disclosed in Patent Literature 1 has the integrated structure in which a plurality of components are combined. Therefore, there may be a problem of cost increase because high machining accuracy is required for the respective components to improve coaxial accuracy. Further, since the integrated actuator, body, and syringe including the valve stem in which the armature portion and needle portion are integrated are attached to the frame, it is difficult to keep mutual coaxial accuracy among the respective components. In the case where the valve structure does not have secured coaxial accuracy, the needle (valving element) is eccentrically fitted into the valve seat. Therefore, durability of the valve may be deteriorated by causing unsymmetrical wear, and stability of the discharge amount may be affected. Further, straightforwardness of droplets at the time of actual discharging may be impaired. In other words, due to eccentricity of an opening state at a discharging portion, an outflowing state of liquid to be discharged may be deteriorated, thereby bringing a situation in which the liquid material cannot be discharged or dripped straight. Furthermore, in the case where coaxial accuracy is not sufficiently secured among the actuator, needle, and valve seat, fluctuation of the discharge amount may be affected by slight rotation of a shaft caused by eccentricity due to vertical movement of the armature at every discharging operation for the liquid material.

Furthermore, according to the invention disclosed in Patent Literature 1, the stroke amount of the valve stem is adjusted by adjusting the clearance between the body and the solenoid by screwing the solenoid into the threaded portion at the upper end of the body fixed to the upper bracket of the frame. Therefore, in this structure, a spring load itself to push back the valve stem to the home position is also increased or decreased along with adjustment of the stroke amount. Therefore, an initial load to the armature caused by attraction from the solenoid is affected by strength of the spring load to push down the valve stem, and a pull-up speed is slowed down at a beginning of excitation, thereby causing response delay in opening the valve and giving an influence such as deviation of the discharge amount from a target value. This phenomenon is particularly obvious in the case of narrowing the clearance between the body and the solenoid, namely, at the time of discharging a small amount. Further, delay in actuating the valve stem at the beginning of excitation may be also impeditive when the valve is opened/closed for a very short period. In other words, in the case of performing control such that a predetermined discharge amount can be obtained by opening the valve by a desired stroke amount for a very short period, such as 5 ms, 3 ms, or shorter than 1 ms, it takes time for the valve stem to start actuating not only in the solenoid but also in the other actuator as the valve stem is constantly applied with the spring force to be pushed back to the home position. Therefore, there may be a problem in which an actual open time of the valve is reduced to an unignorable extent. The shorter the open time is, the larger such an influence becomes, and it may cause a problem in which the discharge amount becomes unstable at the time of discharging a small amount.

Further, the liquid material discharge device according to the invention disclosed in Patent Literature 1 has a structure in which the upper bracket and the lower bracket are cantilevered only by tie rots, and rigidity against the load in an axial direction is low and a space between the upper bracket and the lower bracket is easily broadened. Furthermore, since the integrated solenoid, body, and syringe are set between the upper bracket and the lower bracket, there may be a problem in which the lower bracket is slightly tilted and a position of discharging destination is displaced when air pressure to discharge the liquid material is applied into the syringe and further in the case where the air pressure is increased or decreased in a range of approximately 0.1 MPa to 0.4 MPa. Additionally, rigidity of the frame is low in a longitudinal direction/axial direction, and the space between the upper bracket and the lower bracket is easily broadened. Further, since the integrated actuator, body, and syringe have to be set between the upper bracket and the lower bracket of the frame body in a manner inserting the neck portion of the body between to the bifurcated portion of the upper bracket, the space between the upper bracket and the lower bracket has to be set slightly broader. As a result, even when a valve seat assembly is intended to be set to the frame in a state that the valve seat assembly is not sufficiently screwed into the syringe, i.e., in a state that an entire length of the valve seat assembly is longer than a proper length by an amount not sufficiently screwed into the syringe, the valve seat assembly is set to the frame as it is. Therefore, when the air pressure is applied for discharging, liquid leakage may occur due to insufficient fastening between the syringe and the valve seat assembly.

Further, in the case of adjusting stroke of the valve stem, a state of having no clearance between a stroke adjustment rod and an upper surface of the armature (called zero point) is achieved by closing clearance between the valve stem and the valve seat by screwing the solenoid into the thread portion at the upper end of the body and pressing the valve stem. Then, the stroke adjustment is controlled by rotating the solenoid in an opposite direction while using a scale provided around the solenoid so as to set a desired stroke amount (valve open level) of the valve stem. However, the work to achieve the zero point tends to rely on sense of an operator, and the correct zero point can be hardly achieved. Moreover, in the structure of adjusting the stroke amount of the valve stem by rotating the solenoid itself, there may be a case where the valve stem is curved because large torque is applied to the valve stem. Accordingly, the correct zero point cannot be achieved, and correct stroke is hardly grasped. When the liquid material is discharged, grasping the zero point and stroke adjustment are needed within a range of approximately 0 to 300 μm or 400 μm, but there may be a problem in which the discharge amount cannot be correctly controlled because the stroke adjustment cannot be correctly controlled.

Further, in the related art, many troubles occur at a wetted portion, i.e., a portion contacting the liquid such as a syringe and a cartridge in the liquid material discharge device in which the liquid material is supplied and discharged by a prescribed amount, and to resolve the troubles, the discharge device itself is needed to be disassembled.

Additionally, the liquid material discharge device in the related art is configured exclusively for a syringe or exclusively for a functional cartridge, and there is no device which can be commonly used for both the syringe and a functional module.

The present invention is directed to providing a liquid material discharge device in which the wetted portion can be easily removed. More specifically, the present invention is directed to providing the liquid material discharge device in which only a syringe or a functional cartridge including a valve seat assembly and a needle to open and close the same is removably attached. Further, the present invention is directed to providing a valve which functions only as a system to drive the needle to adjust a discharge amount. Furthermore, the present invention is directed to providing the liquid material discharge device capable of discharging a small amount of liquid material with high accuracy.

### Solution to Problem

To achieve the above-described objects, the invention according to claim 1 provides a liquid material discharge device in which discharging liquid material filled inside a syringe or supplied via a functional cartridge is controlled by opening and closing a needle valve by an actuator under an applied working gas. The liquid material discharge device at least includes: a valve seat assembly attached to a tip of the syringe or the functional cartridge; a needle inserted into the syringe or the functional cartridge and constituting the needle valve in a space with the valve seat assembly; and a valve body including a syringe housing space to house the syringe or the functional cartridge attached with the valve seat assembly and the needle. Further, the valve body includes: the actuator; a driven member formed separately or integrally with the actuator, driven by the actuator, and magnetically coupled to the needle; and a positioning member configured to connect the syringe or the functional cartridge by advancing and retreating the driven member relative to the syringe or the functional cartridge and also configured to bias the syringe or the functional cartridge toward a predetermined position. The syringe or the functional cartridge inserted with the needle and attached with the valve seat assembly can be removably attached to the valve body by magnetically coupling the needle inserted inside the syringe or the functional cartridge to the driven member inside the valve body.

Here, preferably, the valve body includes at least a junction box, a nozzle base to receive and hold the valve seat assembly, and a platform to connect these components and define and form the syringe housing space between the nozzle base and the junction box, and the actuator, the driven member, and the positioning member are included in the junction box, and a passage to supply the working gas supplied via the junction box to the syringe or the functional cartridge is established by the positioning member being connected to the syringe or the functional cartridge.

Further, preferably, in the liquid material discharge device according to the present invention, the actuator is a solenoid, an armature and a connecting member are included in the valve body as the driven members together with the solenoid, and are disposed such that movement of the armature attracted by exciting the solenoid is transmitted to the needle via the connecting member.

Further, preferably, the armature and the connecting member are separable different structures, and further clearance in an axial direction is set between the armature located at a standby position and the connecting member located at a home position, and when the armature is driven by the actuator, only the armature is moved and the connecting member is not moved until the clearance is closed. After the clearance is closed, the armature works with the connecting member to move the needle together.

Further, preferably, the positioning member is configured to: include, at a lower portion, a connecting portion to be fitted into the syringe or the functional cartridge; function as a connection mechanism capable of performing centering and connection of the syringe or the functional cartridge by being fitted into the syringe or the functional cartridge when the positioning member is moved down; and further function as a mechanism to facilitate removal of the syringe or the functional cartridge inserted with the needle by the positioning member being moved up to an upper limit of a movable range and then removed from the syringe or the functional cartridge, and further by pushing up the driven member to make clearance between the driven member and the syringe or the functional cartridge.

Further, preferably, the platform is formed to have a U-shaped cross section and surrounds three surfaces on both right and left sides and back surface except for a front surface side at which the syringe or the functional cartridge is inserted and ejected. More preferably, the syringe or the functional cartridge is housed without being tilted in a horizontal direction by setting a distance between both right and left side walls slightly larger than a maximum diameter portion on the syringe side or the functional cartridge side.

Further, in the liquid material discharge device according to the present invention, preferably, windows through which the syringe or the functional cartridge can be seen are provided at the both right and left side walls of the platform, and an ejection rod passing through the syringe housing space is placed via the windows, and the syringe or the functional cartridge inside the syringe housing space can be ejected by moving the ejection rod toward the front face side along the windows.

Further, preferably, a magnet configured to attract the armature is disposed on a surface facing the actuator while interposing the armature inside the valve body, and the armature is returned to the standby position not only by its own weight but also by being attracted with magnetic force.

Further, in the liquid material discharge device according to the present invention, the valve body includes, in a manner independent from each other, a valve stroke adjustment mechanism configured to control a rising end of the needle, and a biasing mechanism configured to constantly apply biasing force to push back the needle to a home position, and a stroke amount of the needle can be adjusted under constant biasing force.

Here, in the biasing mechanism to constantly apply biasing force to push back the needle to the home position, a length of a space to house the biasing mechanism may be changeable, and the biasing force of the biasing mechanism may be adjustable in a stepless manner. Further, a collar may be housed in a top portion of the space to house the biasing mechanism, and biasing force of the biasing mechanism can be adjusted by changing an effective length of the space to house the biasing mechanism by changing the collar with another collar having a different height. More preferably, the biasing mechanism is formed of a plurality of magnets, and the magnets are disposed such that the same polarities are opposed to each other.

Further, in the liquid material discharge device according to the present invention, an upper end surface of the top portion of the needle is formed in a spherical surface.

Further, the liquid material discharge device according to present invention, preferably, has a structure where the syringe or the functional cartridge in which fastening of the valve seat assembly is insufficient cannot be inserted into the syringe housing space by setting an axial-direction effective length of the syringe housing space longer than an entire length of the syringe or the functional cartridge when the valve seat assembly and the needle are set in home positions, and further by setting the axial-direction effective length of the syringe housing space shorter than a length when clearance is made in a degree that leakage of liquid material inside is caused due to fastening of the valve assembly attached to a tip of the syringe or the functional cartridge.

Further, in the liquid material discharge device according to the present invention, preferably the valve body includes the syringe housing space having a size possible to house the syringe or the functional cartridge having maximum capacity assumed to be used, and the valve body can be attached with the syringe or the functional cartridge of various sizes which can be housed inside the syringe housing space by adjusting a length of the syringe or a length of the functional cartridge by using one or both of a universal type adapter and a plurality of extension rods having different lengths which can be connected to the syringe or the functional cartridge of a plurality of sizes. The adapter is preferably formed as one integrated block including, at an upper end, a plug portion to be connected to the positioning member and, at a different place, a plug portion having a shape conforming to an opening of the syringe or the functional cartridge to be connected, and further the adapter includes a hole configured to pass the needle through centers of the respective plug portions and enable the extension rod to be interposed. The extension rod preferably includes an upper end plug portion to be connected to the positioning member and a lower end plug portion to be directly connected to the adapter, or to the corresponding syringe or the functional cartridge.

Here, in the liquid material discharge device according to present invention, preferably, a guide portion is provided on the valve body side, and positioning on a back side can be controlled by making the guide portion abut against a portion adjacent to the plug portion of the adapter or the extension rod to be connected to the positioning member.

Further, the valve stroke adjustment mechanism is provided with a torque limiter, and a zero point can be correctly achieved by idling the valve stroke adjustment mechanism when torque of a setting value or a higher value is applied to the valve stroke adjustment mechanism.

Further, preferably, in the liquid material discharge device according to the present invention, a lock-up sleeve to be housed in an inner space of the junction box is provided, and the connecting member and the positioning member are housed inside the lock-up sleeve and then housed inside the junction box. The lock-up sleeve preferably includes a dowel which projects from a peripheral surface of the lock-up sleeve, a dowel hole and an L-shaped guide groove are provided on an inner peripheral wall surface defining the inner space of the junction box configured to house the lock-up sleeve. The L-shaped guide groove is preferably formed of a horizontal groove formed in a circumferential direction and connected to the dowel hole, and a vertical groove formed in an axial direction and extending to an opening of the junction box. Preferably, the lock-up sleeve and the junction box are integrally formed by passing the dowel through the guide groove and fitting the dowel into the dowel hole located at an end of the guide groove, and the lock-up sleeve has a structure in which the lock-up sleeve can be attached or removed together with the driven member and the positioning member by applying flushing air to push the syringe to a predetermined position in a state that the dowel is released from the dowel hole and positioned at the vertical groove by rotating the lock-up sleeve in a circumferential direction.

### Advantageous Effects of Invention

According to the liquid material discharge device recited in claim 1, the actuator included in the valve body and the needle inserted into the syringe or the functional cartridge are separate different structures, and both are magnetically coupled in a separable manner. Therefore, the syringe or the functional cartridge inserted with the needle and attached with the seat valve assembly can be easily attached to the valve body and also can be easily removed from the valve body as it is. Moreover, the actuator included in the valve body is not needed to be removed from the valve body at the time of attaching or removing the syringe or the functional cartridge, and also in the case of attaching the syringe again, the syringe or the functional cartridge is set inside the syringe housing space of the valve body, and at the same time, position alignment is automatically performed by a centering effect of magnetic attraction force applied when the actuator and the needle are magnetically coupled. Therefore, in this structure, delicate readjustment at the time of changing the syringe is not necessary. Therefore, adjustment for discharge parameters is not needed again, and discharge can be easily reproduced as it is. Therefore, work to change the syringe or the functional cartridge can be quickly and simply performed.

Furthermore, according to the liquid material discharge device recited in claim 1, the actuator and the needle are more firmly connected by magnetic attraction. Therefore, even when slight misalignment or tilting occurs between the actuator and the needle, no influence is given to transmission of axial-direction movement of the actuator to the needle. Accordingly, as far as coaxial accuracy is secured between the valve seat and the needle inserted into the syringe or the functional cartridge side, rotation caused by eccentricity hardly occurs even when misalignment or core tilting occurs between the actuator and the needle. In other words, precise coaxial accuracy is not necessary between a member on the actuator side and a member on the needle side, and even when the core is slightly misaligned or tilted, straightforwardness is ensured for the needle in which coaxial accuracy is individually secured inside the syringe or the functional cartridge, and further no trouble is given to driving the needle. Therefore, since comprehensive coaxial accuracy is not much required between the respective components, processing cost and labor for the respective component can be largely reduced.

Further, since the actuator and the needle have a relation to work together by magnetic coupling and straightforwardness is ensured for the needle in which coaxial accuracy is individually secured inside the syringe or the functional cartridge, the needle is prevented from being rotated due to eccentricity at every discharging operation for the liquid material even when coaxial accuracy is not sufficiently secured between the actuator and the needle. Further, the needle is prevented from being eccentric relative to the valve seat and hitting the same. Therefore, durability of the valve may not be deteriorated by unsymmetrical wear of the valve seat, the discharge amount may not become unstable, and further straightforwardness of droplets to be discharged may not be impaired. In other words, coaxial accuracy is secured between the valve seat and the needle without influence of misalignment or tilting between the actuator on the valve body side and the needle on the syringe or functional cartridge side. Therefore, an outflowing state of the liquid to be discharged is kept in a good condition and the liquid can be discharged or dripped straightforward.

Further, the liquid material discharge device recited in claim 1 enables the syringe or the functional cartridge to be self-supported because the needle inserted into the syringe or the functional cartridge is brought into a suspended state by the magnetic attraction force in a space with the actuator of the valve body. Moreover, since the syringe or the functional cartridge is biased to a predetermined position and set at the predetermined position by the positioning member, it is possible to avoid a situation in which the position of the syringe or the functional cartridge is displaced during discharging operation, an open level/a stroke amount of the valve fluctuates to cause a change of a discharge amount. Therefore, discharge amount control, especially, control for small amount discharge can be performed with high accuracy.

Further, according to the invention recited in claim 2, the valve body includes at least the junction box, nozzle base, and platform configured to connect these components and define and form the syringe housing space, and further the junction box includes the actuator, the member to be vertically driven by the actuator, and the positioning member configured to attach or remove the syringe or the functional cartridge by vertical movement. Therefore, position alignment between the needle and the driven member to be driven by the actuator is automatically performed by magnetic coupling at the same time when the syringe or the functional cartridge is set inside the syringe housing space, and further the driven member is connected to the needle. As a result, the syringe or the functional cartridge including the valve seat assembly and the needle which opens and closes the same can be set in the syringe housing space of the valve body or removed from the syringe housing space as one block. Moreover, since the syringe or the functional cartridge is set at the predetermined position by the positioning member connected to the syringe or the functional cartridge by fitting, it is possible to avoid a situation in which the position of the syringe or the functional cartridge is displaced during discharging operation and an open level/a stroke amount of the valve fluctuate to cause a change of a discharge amount. Therefore, discharge amount control, especially, control for small amount discharge can be performed with high accuracy.

Further, according to the invention recited in claim 3, the actuator is the solenoid, the armature and connecting member are included in the valve body together with the solenoid as the driven members driven by the solenoid. Therefore, discharge can be performed with excellent responsiveness by transmitting, to the needle via the connecting member, movement of the armature attracted by exciting the solenoid.

Furthermore, according to the invention recited in claim 4, the armature to be magnetically attracted by the solenoid and the connecting member configured to work with the needle are separate different structures, and further the clearance/a run-up space in the axial direction is set between the connecting member and the armature located at the standby position, and only the armature is configured to be pulled up at the beginning of attraction by the solenoid. Therefore, even in the case where the discharge amount is little and a discharging period is short, a period to drive the solenoid can be increased by adding a constant run-up distance/time. In other words, after securing the run-up time enough to attract the armature, the solenoid can be driven for a period required to actually further attract the armature. Moreover, only the armature can be moved without receiving any influence from biasing force applied to push back the needle to the home position at the beginning of excitation. Therefore, operation can be performed without time lag in accordance with excitation of the solenoid. Discharging a small amount is enabled by this. For example, control can be executed so as to achieve a predetermined discharge amount by opening the valve by a desired stroke amount for a short period such as shorter than 1 ms.

According to the invention recited in claim 6, the syringe or the functional cartridge inserted with the needle and attached with the seat valve assembly is attached to the valve body or removed from the valve body as it is only by vertically moving the positioning member. Further, coaxial accuracy between the positioning member and the syringe or the functional cartridge is secured at the same time when connected.

According to the invention recited in claim 7, the platform which connects the junction box to the nozzle base and defines and forms the syringe housing space is formed to have the U-shaped cross section. Therefore, rigidity is generally high, and even when flushing air is applied, the syringe housing space is hardly expanded in a longitudinal direction and the nozzle base is hardly tilted. Therefore, a position of a discharging destination is prevented from being displaced, and a position/target position to apply the liquid material such as an adhesive agent is prevented from being deviated.

According to the invention recited in claim 8, the maximum diameter portion on the syringe side or the functional cartridge side can be housed inside while having very small clearance in the syringe housing space of the valve body. Therefore, the position of the syringe or the functional cartridge is determined without being displaced largely in the horizontal direction. As a result, centering between the valve body and syringe or the functional cartridge is facilitated.

According the invention recited in claim 9, the syringe can be easily ejected from the syringe housing space by moving the ejection rod passing through the syringe housing space along the windows provided at both right and left side surfaces of the platform even in the case where magnetic coupling between the needle and the connecting member is strong.

According to the invention recited in claim 10, the armature is forcibly returned to the standby position by attraction force of the magnet. Therefore, the armature is prevented from delaying in returning to the home position, and ON/OFF operation of the actuator, namely, discharging operation can be performed with quick response. In other words, small amount discharge can be performed with accuracy. Moreover, a space of the valve body is reduced, and dust emission or the like from a junction between a spring and the armature, which is likely to occur in the case of setting the spring or the like, can be prevented, thereby achieving to prevent the liquid material from contamination.

Further, in the liquid material discharge device according to claim 11, the valve stroke adjustment mechanism to control the rising end of the needle and the biasing mechanism to constantly apply biasing force to push back the needle to the home position are provided on the valve body side in a manner independent from each other, and the stroke amount of the needle can be adjusted under the constant biasing force. Therefore, since the constant biasing force is applied without change in order to push the needle back to the home position regardless of magnitude of the stroke amount, not only a speed to pull up the needle at the beginning of excitation is not slowed down but also response delay in opening the valve is not caused even at the time of discharging a small amount, namely, when adjustment is made so as to reduce the stroke amount of the needle. Accordingly, the discharge amount is prevented from an influence such as deviation of the discharge amount from a target value.

Here, since an entire length of the space housing the biasing mechanism which constantly applies biasing force to push back the needle to the home position can be precisely adjusted, biasing force such as a spring load can be adjusted in a stepless manner. Therefore, biasing force is adjusted to optimal strength in accordance with viscosity of the liquid material, and liquid material can be prevented from being splashed after discharge. Moreover, the biasing mechanism in accordance with to a load, for example, a spring for a low load and a spring for a high load are not needed to be prepared in advance for change. Therefore, the number of components is reduced, maintenance for the components is simplified, and further work to change the components is not needed. Furthermore, in the case of changing the effective length of the space by changing, to another collar having a different height, the collar disposed at the top of the space to house the biasing mechanism, biasing force of the biasing mechanism can be gradually and simply adjusted.

Additionally, in the case of utilizing repelling force of the magnet as the biasing mechanism to constantly apply biasing force to push back the needle to the home position, contamination of the liquid material can be prevented by preventing dust emission or the like at the junction of the armature which is likely to occur in the case of using the spring.

Further, according to the invention recited in claim 15, the upper end surface of the top portion of the needle is formed in the spherical surface. Therefore, there is a less possibility of interfering with the driven member included in the valve body when the syringe or the functional cartridge is tilted in order to remove the same from the valve body, thereby smooth removing can be performed. Moreover, in the case where an angle of a contacting surface between the needle and the actuator connected by magnetic coupling is varied, the surface attracted by the magnet is prevented from uneven contact. Therefore, high machining accuracy is not needed for the connecting surface.

Further, according to the invention recited in claim 16, housing the syringe or the functional cartridge into the syringe housing space of the valve body cannot be executed in the case where attachment of the same is performed in a state that clearance remains to such an extent that leakage of the liquid material filled inside is caused even after fastening of the valve assembly attached to a tip of the syringe or the functional cartridge. Therefore, maintenance can be easily and suitably performed for one unit in which the valve assembly is combined with the syringe or the functional cartridge, and leakage caused by insufficient fastening of the valve seat assembly is prevented from occurring.

Further, according to the invention recited in claim 17, the syringe or the functional cartridge of various sizes can be attached to a single valve body by changing orientation of the universal type adapter or combining the extension rod. In other words, the single valve can be commonly used for not only various kinds and various types of the syringes but also the functional cartridges.

Further, according to the invention recited in claim 18, positioning control on the back side can be performed by making the guide portion on the valve body side abut against the portion adjacent to the plug portion of the adapter or the extension rod to be connected to the positioning member. Therefore, substantial alignment relative to the positioning member which is moved down can be performed only by making the adapter or the extension rod be pressed against the guide portion, thereby achieving smooth fitting. Moreover, by forming shapes of the portions of the adapter and extension rod abutting against the guide portion in a common shape, positioning becomes possible even in the case of attaching the syringe or the functional cartridge having different sizes and shapes.

Further, according to the invention recited in claim 19, the zero point can be correctly achieved by the valve stroke adjustment mechanism idling at the time of stroke adjustment for the needle. Therefore, desired clearance is formed at an upper end portion of a stroke adjustment rod by rotating a micro adjustment cap by a desired amount based on the detected zero point, and a desired stroke amount of the needle can be correctly set. Therefore, since stroke adjustment can be correctly controlled even in a micro range such as about 0 to 300 μm or 400 μm required at the time of discharging the liquid material, discharge amount can be correctly controlled.

Further, according to the invention recited in claim 20, the lock-up sleeve can be ejected outside the junction box in a moment only by rotating the lock-up sleeve in an opposite direction up to the vertical groove portion of the L-shape guide groove and applying flushing air, utilizing action of downward movement of the positioning sleeve. Therefore, the positioning member, armature, and connecting member can be easily ejected outside the junction box together with the lock-up sleeve, and maintenance can be easily performed by disassembling the components into respective components. Further, upon completing maintenance for the components, the lock-up sleeve is inserted into the inner space of the junction box after assembling the components inside the lock-up sleeve, and the lock-up sleeve is fixed to the junction box only by rotating the lock-up sleeve toward the dowel hole.

### BRIEF DESCRIPTION OF DRAWINGS

FIG. 1 is an exploded perspective view illustrating an embodiment in which a liquid material discharge device according to the present invention is applied to a syringe.

FIG. 2 is a perspective view illustrating the liquid material discharge device of FIG. 1 in an assembled state.

FIG. 3 is a front view of FIG. 2.

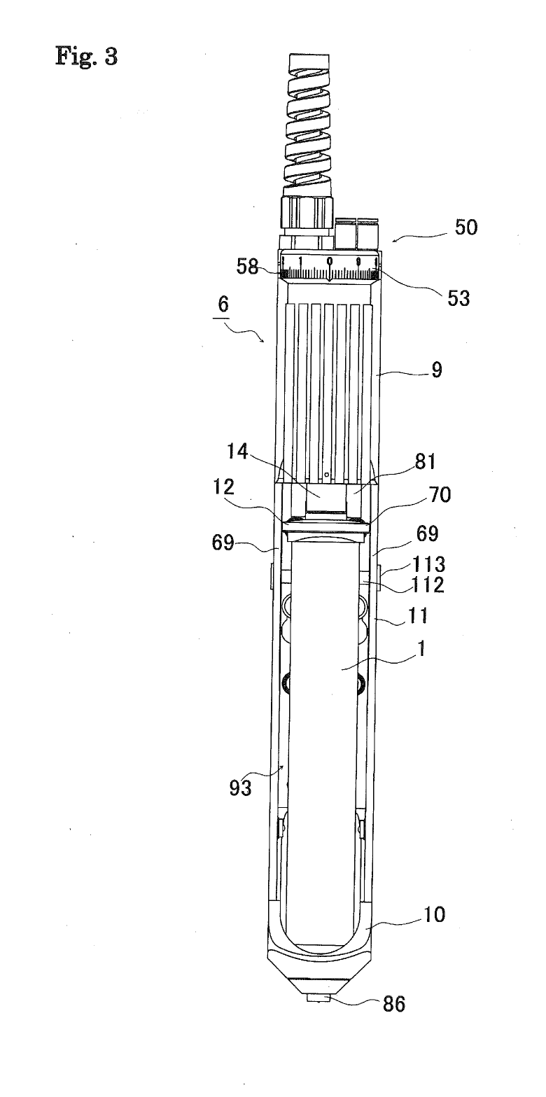

FIG. 4 is a central longitudinal sectional view of the liquid material discharge device according to the present invention in the assembled state.

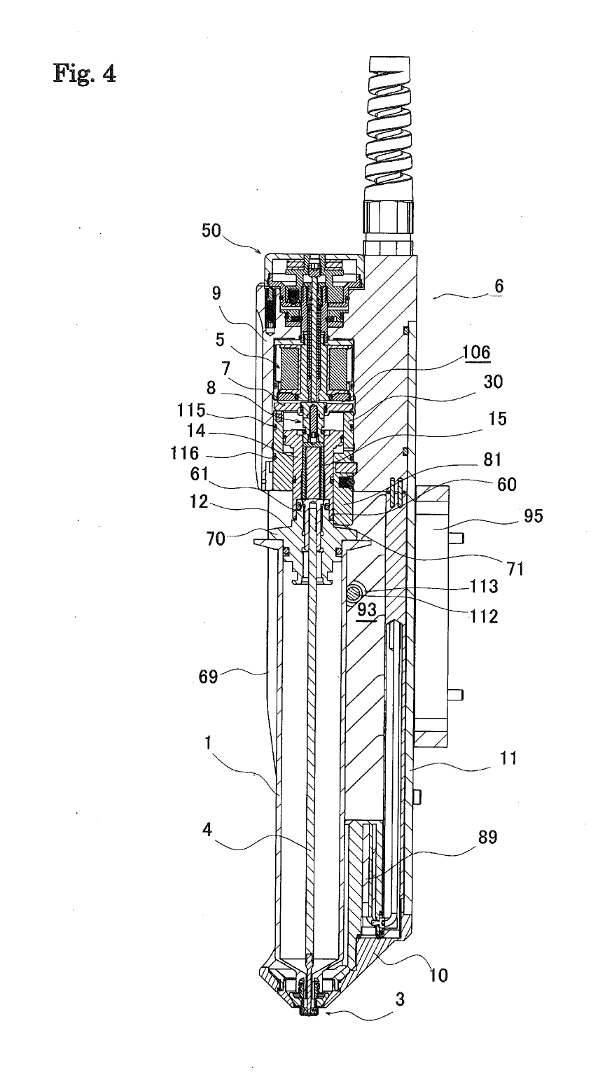

FIG. 5 is an enlarged central longitudinal sectional view of a junction box portion in FIG. 4.

FIG. 6 is an enlarged central longitudinal sectional view illustrating a relation between a solenoid, an armature, and a connecting member in FIG. 4.

FIG. 7 is an enlarged central longitudinal sectional view illustrating a relation between the connecting member, an adapter, and a positioning member in FIG. 4.

FIG. 8 is an enlarged central longitudinal sectional view illustrating a relation between a valve seat assembly and a nozzle base of a valve body in FIG. 4.

FIG. 9 is an enlarged central longitudinal sectional view from a side surface, illustrating a relation between the connecting member, an extension rod, and the adapter.

FIG. 10 is an enlarged central longitudinal sectional view from a front surface side, illustrating a relation between the connecting member, the extension rod, and the adapter.

FIG. 11 is an exploded perspective view illustrating a relation between the valve body and a bracket.

FIG. 12 is a central longitudinal sectional view illustrating a relation between a syringe, a needle, and the adapter.

FIG. 13 is a central longitudinal sectional view illustrating a state in which the syringe is removed from the valve body.

FIG. 14 is an exploded perspective view illustrating the embodiment in which the liquid material discharge device according to the present invention is combined with the syringe and extension rod.

FIG. 15 is an exploded perspective view illustrating an embodiment in which the liquid material discharge device of the present invention is applied to a pump circulation supply system using a functional cartridge.

FIG. 16 is a central longitudinal sectional view illustrating a structure of the functional cartridge in FIG. 15.

FIG. 17 is an exploded perspective view illustrating an embodiment in which the liquid material discharge device of the present invention is applied to a pressurized tank supply system using the functional cartridge.

FIG. 18 is an exploded perspective view illustrating an embodiment in which the liquid material discharge device of the present invention is applied to an external syringe supply system using the functional cartridge.

FIG. 19 is a central longitudinal sectional view illustrating a different embodiment of the liquid material discharge device according to the present invention, in which a part of an extension rod is illustrated together with a junction box portion.

### REFERENCE SIGNS LIST

1 Syringe
2 Functional cartridge
3 Valve seat assembly
4 Needle
5 Actuator
6 Valve body
7 Armature
8 Connecting member
9 Junction box
10 Nozzle base
11 Platform
12 Universal adapter
13 Extension rod
14 Positioning member
15 Magnet
16 Hook
17 Yoke
21 Connect sleeve
24 Biasing mechanism to constantly apply biasing force to push back needle to home position
30 Lock-up sleeve
32 Stroke adjustment rod
36,43 Coil core and upper core forming space to house biasing mechanism to push back needle to home position
42 Magnet to attract armature
44 Resin collar to change effective length of biasing mechanism housing space
45 Spring plug to vary length of biasing mechanism housing space
46 Valve seat
49 Upper end surface of top portion of needle
50 Valve stroke adjustment mechanism to control rising end of needle
51 Torque limiter
60 Connecting portion of positioning member (connecting port)
61 Plug of adapter to be fitted into connecting portion of positioning member (third plug)
62 Plug of extension rod to be fitted into connecting portion of positioning member
69 Right and left side walls of platform
70 Flange portion of universal adapter
71 Second shoulder portion of adapter (portion adjacent to plug portion to be fitted into connecting portion of positioning member)
72 First plug portion of universal adapter
73 Second plug portion of universal adapter
74 First shoulder portion of universal adapter
75 Hole of universal adapter
80 Positioning shoulder portion of extension rod (portion adjacent to plug portion to be fitted into the connecting portion of positioning member)
81 Guide portion on valve body side
93 Syringe housing space
94 Lower end plug portion of extension rod
106 Internal space to house mechanism unit of junction box

### BEST MODE FOR CARRYING OUT THE INVENTION

In the following, structures of the present invention will be described based on embodiments illustrated in the drawings. Note that, unless otherwise particularly specified, a vertical direction indicates a longitudinal direction of a valve body (moving direction of a needle to open and close a valve: axial direction), an upper side indicates a junction box side of the valve body, and a lower side indicates a nozzle base side. Further, note that a front-back direction indicates a backward direction orthogonal to the longitudinal direction of the valve body, a back side indicates a back side of the valve body, and a front side indicates a front side at which a syringe is inserted and ejected. Additionally, a horizontal direction is a width direction orthogonal to each of the longitudinal direction and front-back direction of the valve body, and in the case of moving in the longitudinal direction, movement is referred to as moving vertically, upward, or downward regardless of actual orientation of the valve body. Furthermore, a liquid material discharge device according to the present invention, which is generally referred to as a valve, normally discharges liquid material downward, but there may be a case where the liquid material is discharged obliquely downward by changing a setting angle of the valve body in accordance with a shape of an object to which the liquid material is applied. However, in the present specification, the case of performing downward discharging will be mainly described.

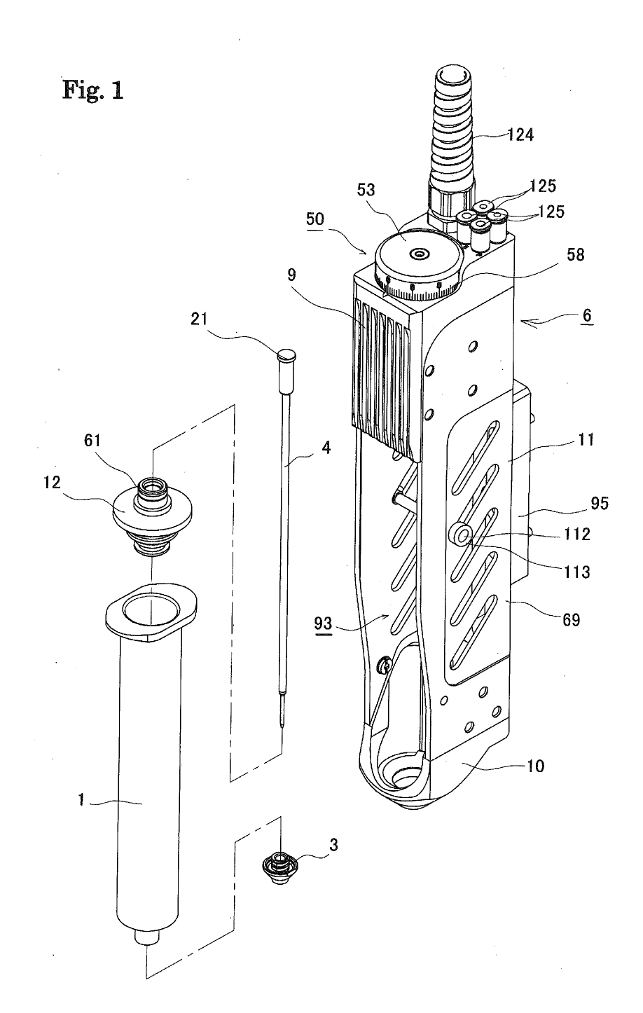

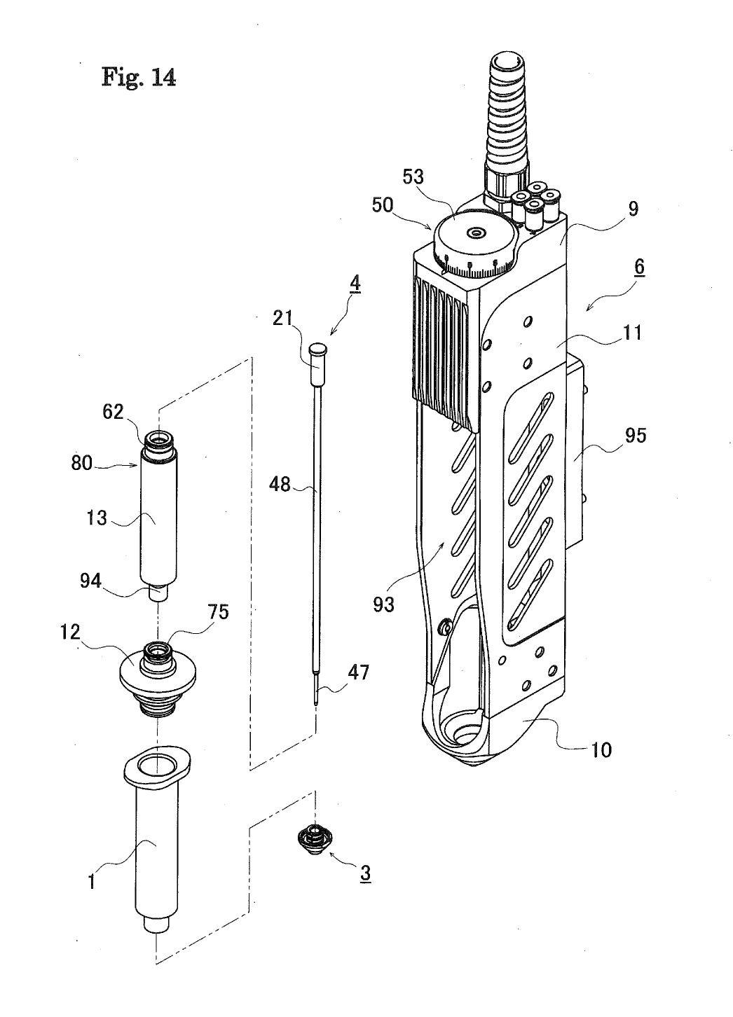

The liquid material discharge device according to the present invention (generally referred to as the valve) at least includes, as illustrated in FIG. 1 or FIG. 14: a valve seat assembly 3 attached to a tip of a syringe 1 or a functional cartridge 2; a needle (valving element) 4 inserted into the syringe 1 or the functional cartridge 2 and contacting a valve seat 46 of the valve seat assembly 3 at the tip; and a valve body 6 in which an actuator 5 is included. The actuator 5 holds the syringe 1 or the functional cartridge 2 in a removable manner and is magnetically coupled with the needle 4 housed inside the syringe 1 or the functional cartridge 2, and advances and retreats the needle 4 relative to the valve seat. The actuator 5 of the valve body 6 is magnetically coupled and integrated with the needle 4 attached inside the syringe 1 or the functional cartridge 2 only by setting, to the valve body 6, the syringe 1 or the functional cartridge 2 preliminarily attached with the needle 4 and the valve seat assembly 3, and discharging the liquid material filled inside the syringe 1 or the liquid material supplied via the functional cartridge 2 is controlled by the actuator 5. Meanwhile, the needle 4 may be directly driven by the actuator 5 included in the valve body 6 or may be indirectly driven via a member to be driven by the actuator 5. Accordingly, in the present embodiment, a description will be mainly given by exemplifying a case in which a solenoid having excellent responsiveness is adopted as the actuator 5 (hereinafter also referred to as solenoid 5 to indicate the actuator), and an armature 7 and a connecting member 8 are included in the valve body 6 as members to be driven by the actuator 5 (hereinafter also collectively referred to as driven side members), and movement of the armature 7 attracted by exciting the solenoid is transmitted to the needle 4 via the connecting member 8.

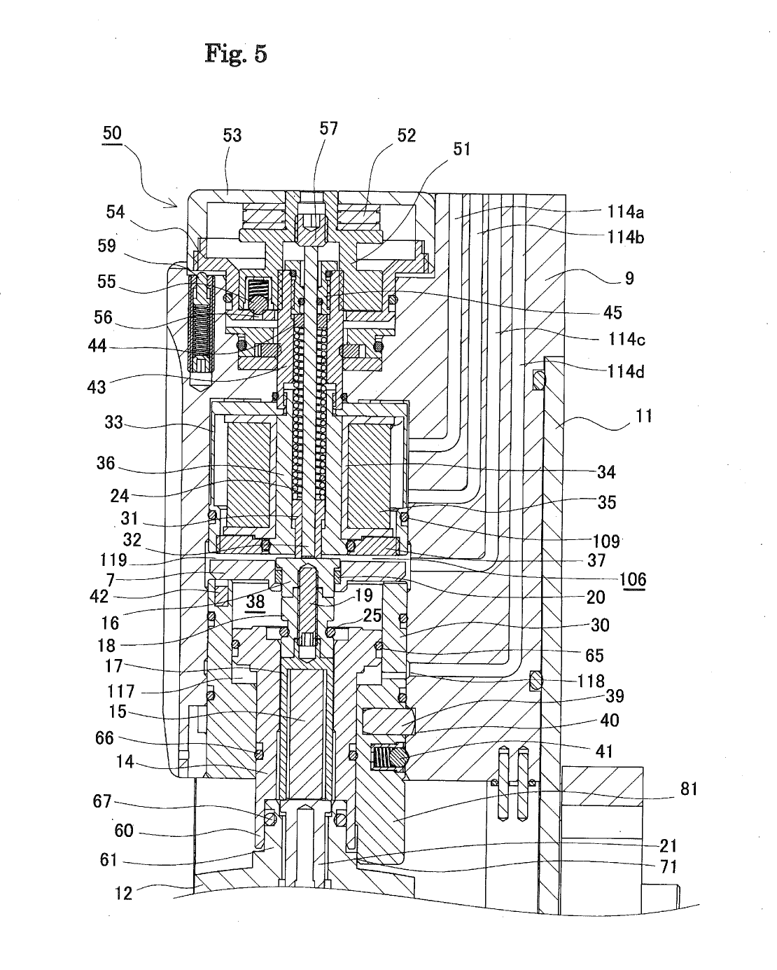

Here, the valve body 6 includes at least, as illustrated in FIGS. 1 and 5, a main frame (referred to as a junction box in the present specification) 9, a nozzle base 10 to receive and hold the valve seat assembly 3, and platform 11 connecting the mentioned components with three surfaces and having a U-shaped cross section. The main frame 9 is a box-shaped frame to house a mechanism unit configured to connect and drive the syringe 1 or the functional cartridge 2, and also functions as the junction box to connect a power supply means, such as a power cable 124 and an air hose 125 for applying air pressure, to the mechanism unit. Further, the junction box 9 is also provided with the solenoid 5 as the actuator, the armature 7 and the connecting member 8 as the driven members to be vertically driven by the solenoid 5, and a positioning member 14 which is vertically moved by application of air pressure and fitted into an adapter 12 or an extension rod 13 on the syringe 1 or the functional cartridge 2 side. The junction box 9 is connected to the needle 4 included in the syringe 1 or the functional cartridge 2 by magnetic coupling, thereby enabling the syringe 1 or the functional cartridge 2 inserted with the needle 4 to be attached to or removed from the valve body 6. In other words, the connecting member 8 constituting a part of the driven side member and the needle 4 are formed in separate structures, and firm connection is made between both structures by using a magnet 15 when both structures are needed to be connected. Therefore, when the syringe 1 or the functional cartridge 2 is set inside the platform 11, alignment between the needle 4 and the connecting member 8 which is moved integrally with the armature 7 is automatically performed by magnetic coupling at the same time. Therefore, delicate readjustment required at the time of changing the syringe is not needed in this structure. As a means to magnetically couple the needle 4 to the connecting member 8 which is a part of the actuator 5 or the member to be driven by the actuator 5, the magnet 15 is used and disposed at a part of the actuator 5 inside the valve body 6 or at least one or preferably both of the connecting member 8 side and the needle 4 side.

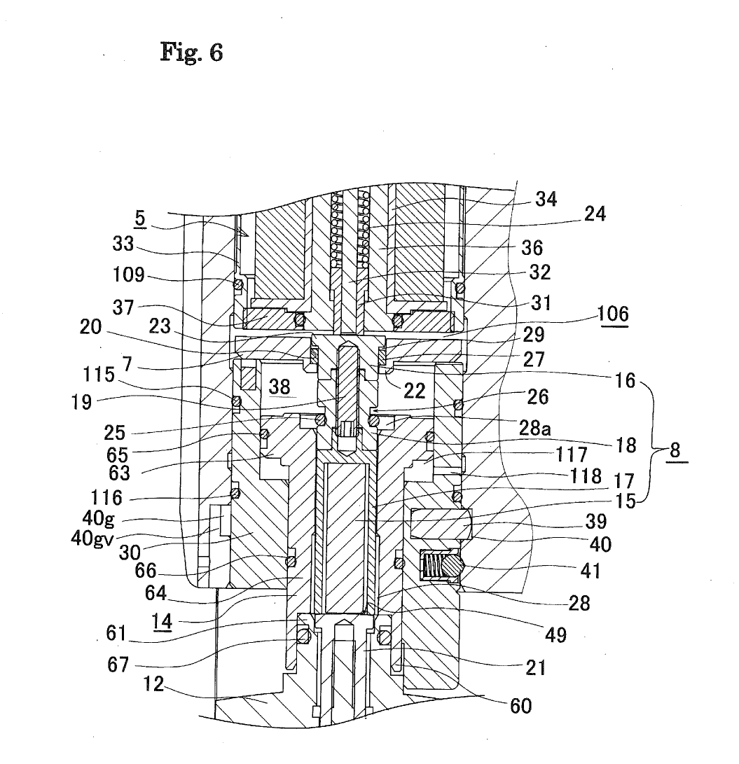

In the case of the present embodiment, the connecting member 8 includes, as illustrated in FIGS. 5 and 6, a hook 16 to be engaged only when the armature 7 is moved up by magnetic attraction of the solenoid 5, a yoke 17 housing the magnet 15 to magnetically attract a connect sleeve 21 at a head portion of the needle 4, an intermediate connector 18 made of non-ferrous metal or engineering plastic and disposed between the mentioned components to cut off magnetism, and a threaded shaft 19 to mutually connect the mentioned components. Further, the hook 16 is disposed so as to pass through a hole 20 provided at a center of the armature 7 and includes, at an upper portion, a flange 23 directed outward in a radial direction and configured to be engaged with a flange 22 projecting inward from a bottom portion of the hole 20 in a radial direction. The hook 16 is provided to work only with the armature 7 being moved upward by engaging the flange 22 on the armature 7 side with the flange 23 at the upper portion. In other words, the hook 16 does not work with the armature 7 being moved downward because the flanges 22, 23 are brought into a relation to be moved in a direction away from each other, and the hook 16 is forcibly moved down by biasing force of a biasing means 24 to push back the needle 4 to a home position. Meanwhile, an annular groove 26 is formed on an outer peripheral surface of the intermediate connector 18, and an O-ring 25 is housed therein. Further, the yoke 17, intermediate connector 18, and hook 16 have the same outer diameter and are disposed so as to pass through a hole 28 at a center of the positioning member 14.

Further, as illustrated in FIG. 6, between both the armature 7 located at a standby position and the hook 16 of the connecting member 8 located at a home position, clearance 29 in the axial direction is set between mutually facing surfaces of the flanges 22, 23 of both the armature 7 and the hook 16. When the armature 7 is started moving by the solenoid 5, the needle 4 is not moved and only the armature 7 is moved in an interval of the clearance 29. Further, when the clearance 29 between the armature 7 and the hook 16 of the connecting member 8 is eliminated and both components contact, the hook 16 is moved by the armature 7 and the needle 4 is moved together via the connecting member 8. With this structure, only the armature 7 can be moved by receiving attraction of excitation without receiving strong biasing force of the biasing means 24, such as a spring load, which tries to push back the needle 4 to the home position at the beginning of excitation. Therefore, an initial load to pull up the needle 4 is reduced and also a period to actually excite the solenoid 5 becomes longer than a period of pulling up the needle 4 (valve injection period) originally required, and attraction force of the solenoid is enhanced. As a result, the needle can be surely driven even when a discharging period is short, and a smaller amount of the liquid material can be discharged. In other words, the armature 7 does not constantly work with the hook 16, and a run-up section is provided. In the run-up section, the needle 4 is not moved and only the armature 7 is moved at the beginning when the armature 7 is started moving from the standby position. By increasing an entire period of driving the solenoid 5 by adding, to an actual discharging period, the constant run-up time only for the armature 7, the armature 7 is more easily attracted even for a short discharging period. By setting the run-up section, the armature 7 can be surely driven, and a shorter discharging period can be achieved. Generally, the shorter an excitation period of the solenoid 5 is, the weaker attraction force is, and therefore, there may be a problem in which the armature 7 cannot be attracted. However, since there is the run-up section in which only the armature 7 is moved by attraction of the solenoid 5, the armature 7 can be more easily attracted (pulled up) and the smaller amount of liquid material can be correctly discharged. Here, the standby position means a position under a situation that the armature 7 is placed on an upper end surface of a lock-up sleeve 30. Meanwhile, needless to mention, the technology in which the armature 7 is separated from the connecting member 8 and clearance 29 in the axial direction is provided therebetween to provide the run-up section in which only the armature 7 is moved at the beginning of drive can be applied to a valve in which the solenoid is used as the actuator, for example, the valve disclosed in JP 2001-157862 A.

Further, a structure is formed by separating the armature 7 from the hook 16 and further setting the clearance 29 in the axial direction between these separated components, in which force of the biasing means 24 to push back the needle 4 to the home position is not received on the armature 7 side although the force of the biasing means 24 to push back the needle 4 to the home position is loaded to the hook 16 on the needle 4 side via a pusher 31. Therefore, attraction delay due to influence of force of the biasing means 24 (spring load) can be reduced at the beginning of exciting the solenoid 5. Note that the clearance 29 in the axial direction is provided under the condition that a resin block 27 is disposed between the flange 22 on an inner side of the armature 7 and the flange 23 on an outer side at the upper end of the hook 16 in order to prevent abrasion caused by collision between metal components. Of course, in the case of forming the hook 16 itself from resin, it is not necessary to dispose the resin block 27 for buffering.

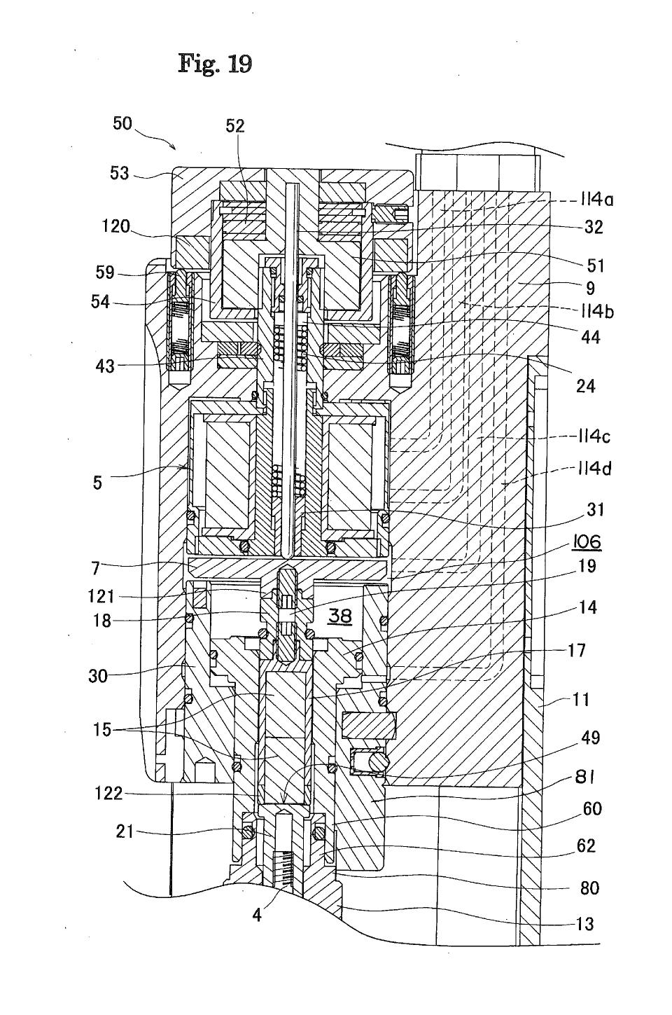

Note that, in the present embodiment, the armature 7 and the connecting member 8 as the driven side members to be driven by the actuator 5 are separable different structures, but not limited thereto, the armature 7 and the connecting member 8 may be formed integrally or may be integrated by screwing, welding, or the like. For example, as illustrated in FIG. 19, a boss 121 is integrally formed with the armature 7 by cutting or the like. The boss 121 includes a threaded hole and an uneven portion to be fitted into an uneven portion on an end surface of the intermediate connector 18 on a back surface side of the disk-shaped armature 7. Then, integration may be made by connecting the intermediate connector 18 with the yoke 17 housing the magnet 15 with the threaded shaft 19. In the case where the attraction force of the solenoid 5 is so strong that the run-up space for the armature 7 is not needed, delay is not caused in a relation between application by the solenoid 5 and movement of the armature 7 even without existence of the run-up section only for the armature 7, and direct driving can be performed. Therefore, the discharge device capable of performing high-cycle discharge can be implemented. In other words, the armature 7 and the connecting member 8 are not constantly needed to be separated, but needed to be separated from needle 4.

Further, the hook 16 constituting the connecting member 8, intermediate connector 18, and yoke 17 may be basically integrally formed, but according to the present embodiment, the components are formed as the separate structures in order that non-ferrous metal or engineering plastic can be adopted for the intermediate connector 18 to cut off magnetism between the armature 7 and the magnet 15.

Further, according to the present embodiment, the magnet 15 is surrounded by the yoke 17, but even in the case of not using the yoke 17, it is preferable to provide a surrounding structure to hold the magnet 15 on the hook 16 side while protecting the magnet 15 which is fragile and weak to impact. For example, as illustrated in FIG. 19, a tip side of the yoke 17 contacting the connect sleeve 21 may be formed with a resin sleeve 122. In this case, abrasion between an upper end surface 49 of the metal-made connect sleeve 21 and the yoke 17 can be prevented. This prevents dust emission between the magnet 15 and the connect sleeve 21 caused by existence of clearance formed between the magnet 15 and the upper end surface 49 of the connect sleeve 21. The structure of surrounding the magnet 15 with the yoke 17 is preferable because an upper face of the hook 16 does not become a surface having polarity relative to attraction of the solenoid 5.

The junction box 9 includes a round-shaped inner space 106 opened downward to house the mechanism unit, and a recessed portion opened upward to mount a valve stroke adjustment mechanism. Four air passages 114a to 114d are opened on an inner peripheral surface defining the inner space 106 to house the mechanism unit, and also the inner space 106 and the recessed portion mutually communicate via a through-hole opened at a center of the division wall partitioning these portions. Therefore, as illustrated in FIG. 5, the solenoid 5 to be housed is fixed while air tightness is achieved in a space with the junction box 9 by an O-ring 109 fitted into an outer peripheral surface of a housing 33. More specifically, a coil 35 wound on a bobbin 34 is covered by the housing 33, a coil core 36 is fitted in a manner passing through a center hole of the bobbin 34, a bottom opening of the housing 33 is closed by an insulation plate 37, and the solenoid 5 is fixed in the inner space 106 of the junction box 9. Further, inside the inner space 106 of the junction box 9, the lock-up sleeve 30 having an outer peripheral surface fitted with O-rings 115, 116 is housed. The positioning member 14 is supported by the lock-up sleeve 30 in a retractable manner. The armature 7 is housed in a space 38 with the solenoid 5 located above a piston 63 of the positioning member 14 surrounded by the lock-up sleeve 30, and the armature 7 is disposed movable in the axial direction by being attracted to the solenoid 5 side by excitation of the solenoid 5. Note that the positioning member 14 is not necessarily housed in the inner space 106 of the junction box 9 after being housed in the lock-up sleeve 30 which also functions as a cylinder, and as the case may be, the positioning member 14 may be directly housed inside the inner space 106 of the junction box 9 without using the lock-up sleeve 30, and then supported in a retractable manner by being covered with an annular seat plate or the like.

The lock-up sleeve 30 is disposed at the junction box 9 in a removable manner. More specifically, the lock-up sleeve 30 is integrally formed with the junction box 9 by forming a dowel 39 projecting from a peripheral surface of the lock-up sleeve 30 and fitting the dowel 39 into a dowel hole 40 provided on an inner peripheral wall defining the inner space 106 to house the mechanism unit of the junction box 9 as illustrated in FIG. 6, for example. The dowel 39 is passed through an L-shaped groove 40g and is fitted into the dowel hole 40 at an end of the L-shaped groove 40g on the back side. The L-shaped groove 40g is formed of a vertical groove formed on the inner peripheral wall of the junction box 9 and extending in the axial direction from an edge of a lower end opening, and a horizontal groove formed in a circumferential direction. In the case of the present embodiment, three dowels 39 are provided in the circumferential direction of the lock-up sleeve 30 at equal intervals, and introduced from the three L-shaped grooves 40g formed on the inner peripheral surface of the junction box 9, and then fitted into the three dowel holes 40 disposed at equal intervals. Therefore, once the dowel 39 is removed from the dowel hole 40 by rotating the lock-up sleeve 30 in an opposite direction to move the dowel 39 in the circumferential direction up to a vertical groove portion 40gv of the L-shaped groove 40g (opposite end of the horizontal groove), the lock-up sleeve 30 can be removed from the junction box 9 by being moved in the axial direction. Further, a ball plunger 41 is provided on the peripheral surface of the lock-up sleeve 30 and disposed such that the junction box 9 is positioned and fixed by the ball plunger 41 being fitted into a recessed portion opened on the inner peripheral surface of the junction box 9. Note that a space between an outer peripheral surface of the lock-up sleeve 30 and the inner peripheral surface of the junction box 9 is sealed with the O-rings 115, 116 fitted into the outer peripheral surface of the lock-up sleeve 30. Therefore, a working gas supplied to the space 38 above the piston 63 of the positioning member 14 and a space 117 below the same does not leak from between the lock-up sleeve 30 and the junction box 9.

Further, a magnet 42 to attract the armature 7 is disposed on a surface of the lock-up sleeve 30 facing the solenoid 5 and provided so as to return the armature 7 to the standby position not only by its own weight but also by being attracted by magnetic force. Here, the magnets 42 disposed at three points at equal intervals in the circumferential direction have magnetic force far weaker than attraction force of the solenoid 5, and do not become resistance against the solenoid 5 attracting the armature 7 upward. Of course, the armature 7 may be made to fall only by its own weight to be returned to the standby position, but there is a limit in a falling speed (movement speed). Therefore, it is preferable to dispose the magnet 42 to forcibly return the armature 7 to the standby position because returning of the armature 7 to the home position, namely, falling of the armature 7 may be delayed in the case of ON/OFF operation with quick response. Meanwhile, a means to return the armature 7 to the standby position is not particularly limited to the magnet 42, and as the case may be, biasing force may be constantly applied from the solenoid 5 side to the lock-up sleeve 30 side by a compression spring or the like. But, attraction by the magnet 42 is more preferable because the space can be saved and dust emission, etc. at a junction between the spring and the armature 7, which is likely to occur in the case of providing the spring or the like, can be prevented.

The junction box 9 is further provided with a valve stroke adjustment mechanism 50 to adjust stroke of the needle 4, and a biasing mechanism 24 to constantly apply biasing force to push back the needle 4 to the home position in a manner independent from each other. The stroke of the needle 4 can be adjusted under a constant spring load, and a strong load is prevented from being applied at the beginning of excitation at the time of discharging a small amount. More specifically, the armature 7 and the connecting member 8 are separate structures, and a tip of a stroke adjustment rod 32 contacts only the hook 16 of the connecting member 8 such that a rising end of the needle 4 can be controlled. On the other hand, a spring housing space is formed around the stroke adjustment rod 32 by the coil core 36 and an upper core 43 mutually connected by a screw, in which a sleeve-shaped pusher 31 to be pushed against the hook 16 and a spring as the biasing mechanism 24 to bias the force to push back the needle 4 to the home position by pushing down the pusher 31 against the hook 16 are disposed. Above the spring 24, a spring plug 45 is disposed via a resin collar 44 so as to deform and displace the spring 24 in a desired manner. With this structure, constant spring force to push back the needle 4 to the home position is applied regardless of the discharge amount, namely, the stroke amount. Therefore, the spring load is prevented from being strong at the time of discharging a small amount. Further, the problem of attraction delay at the beginning of excitation is not caused by influence of the constant spring load regardless of the discharge amount, namely, the stroke amount. Of course, even when the armature 7 and the connecting member 8 are not formed as the separate structures, the stroke adjustment rod 32 and the spring 24 to push back the needle 4 to the home position act on the hook 16 of the connecting member 8 independently from each other. Therefore, stroke adjustment by the stroke adjustment rod 32 and load fluctuation of the return coil spring 24 can be separated. Note that one continuous space/spring housing space is defined by the coil core 36 and the upper core 43 in the present embodiment, but as the case may be, the space may be formed by a single coil core or may be formed by a cylindrical component irrelevant to a solenoid component.

Further, in the case of the valve stroke adjustment mechanism of the present embodiment, the spring plug 45 is provided at the screw at an upper portion of the upper core 43 which projects from the inner space 106 side mainly housing the mechanism unit such as the solenoid 5 to the recessed portion side housing the valve stroke adjustment mechanism 50 such that the upper core 43 passes through the through hole provided at the center of the division wall that partitions these portions. Therefore, a length of a space to house the spring 24 to push back the needle 4 to the home position can be changed by rotating the spring plug 45, and the spring load can be adjusted. With this structure, the spring load can be adjusted in a stepless manner just by rotating the plug 45 without changing the spring 24 itself to a spring for a light load or a spring for a heavy load. In the case where the spring load is constant, liquid material may splash after being discharged depending on viscosity of the liquid material. For example, in the case where the liquid material has low viscosity, there may be a case in which droplets of the liquid material may splash due to a too strong spring load, and adhere to a place other than a desired place. Therefore, the spring load is adjusted by changing the length of the space to house the spring 24, thereby achieving to prevent the liquid material from splashing after being discharged. Note that the biasing means 24 to push back the needle 4 to the home position is not limited to the spring like the present embodiment, and as the case may be, a magnet (not illustrated) can be also applied. In such a case, for example, a ring-shaped magnet may be disposed so as to cause mutual repulsion, and the pusher 31 may be biased against the hook 16 by the repelling force of the magnet. Pushing back the needle 4 by using the magnet is preferable because dust emission or the like can be prevented as well.

Further, the spring force can be adjusted by not limited to the screw adjustment method by the above-described spring plug 45 but also, for example, changing an effective length of the space to house the spring 24 by re-arranging the resin collar 44 from among plural kinds of resin collars having different heights while keeping the spring plug 45 at a fixed position. In this case, delicate adjustment for a fastening amount of the spring plug 45 is not necessary, and adjustment of the spring load can be completed only by fastening the spring plug 45 up to a predetermined position while setting a resin collar 44 selected from among the plural kinds of resin collars 44 having the different heights.

Further, in the case where the spring 24 is used as the biasing mechanism, dust emission can be easily prevented by covering the outside of the spring 24 with a sheath made of resin material having a low friction coefficient and low abrasion properties such as polytetrafluoroethylene, polyacetal, and polyamide, or a sheath having an inner peripheral surface coated with a low friction coating agent such that the spring 24 is relatively slid along the sheath, although not illustrated. Further, since the stroke adjustment rod 32 is generally mirror-finished, dust emission can be easily prevented also by adjusting a winding diameter of the spring 24 such that the outer peripheral surface side of the spring 24 is separated from the coil core 36 and the inner peripheral surface side of the spring 24 relatively slides along the stroke adjustment rod 32.

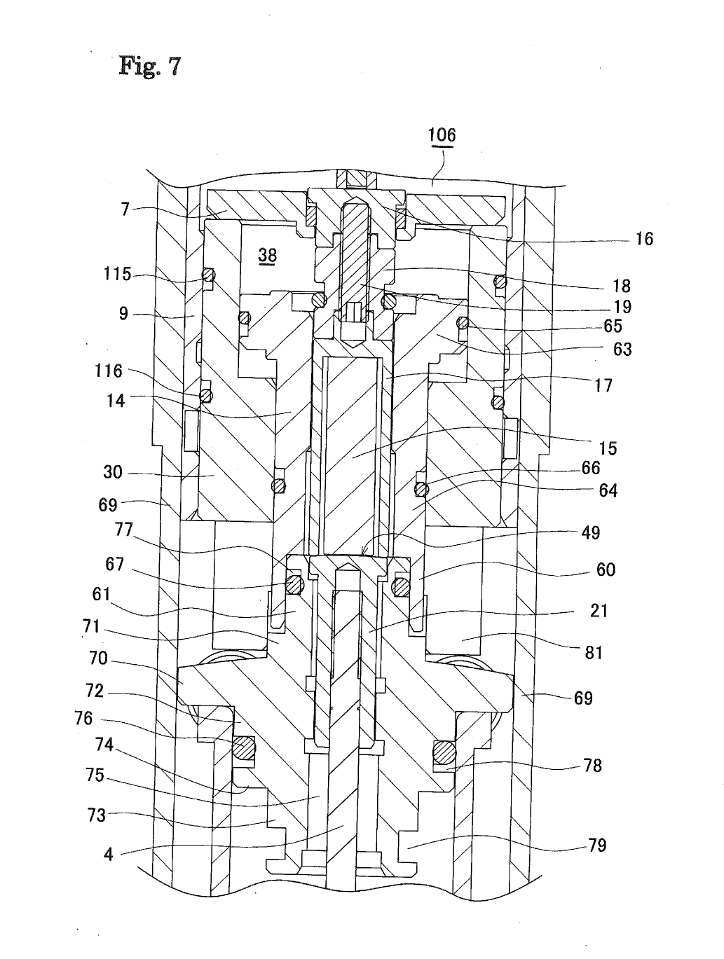

The needle 4 of the present embodiment includes, as illustrated in FIG. 7, an impact stick 47 made of tungsten carbide and located at the tip portion contacting the valve seat 46, an impact rod 48 made of stainless steel and supporting the impact stick 47, and the connect sleeve 21 capping a head portion of the impact rod 48, namely, the head portion of the needle 4. In the case of the present embodiment, the connect sleeve 21 formed of ferromagnetic material caps the head portion of the impact rod 48 in order to be magnetically coupled to the connecting member 8 of the valve body 6, but not limited thereto, in the case where an entire portion of the needle 4 or the impact rod 48 is formed of the ferromagnetic material, the connect sleeve 21 not especially needed. Of course, in the case where the magnet 15 is mounted on a top portion of the needle 4, there is no influence of material of the needle 4.

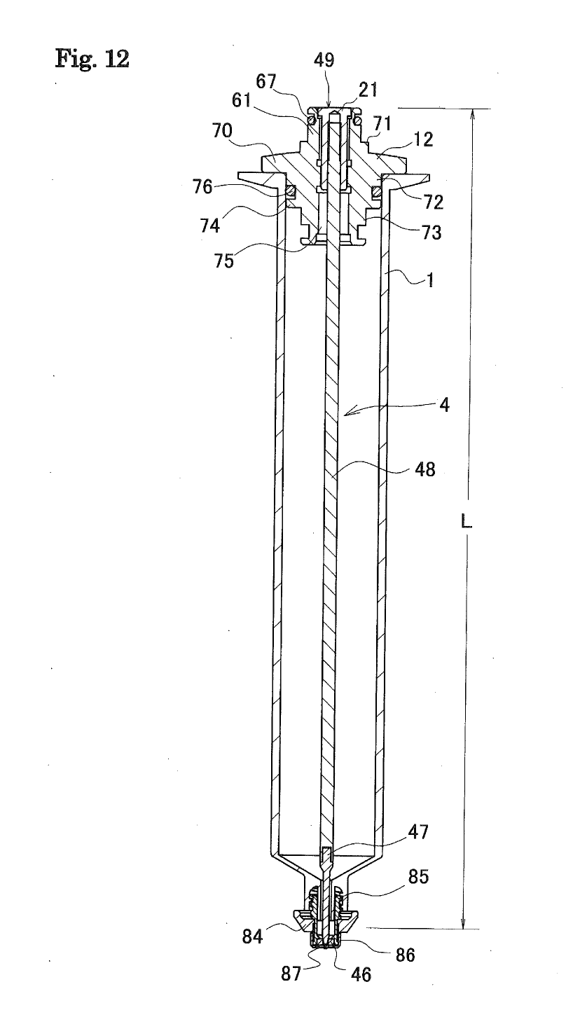

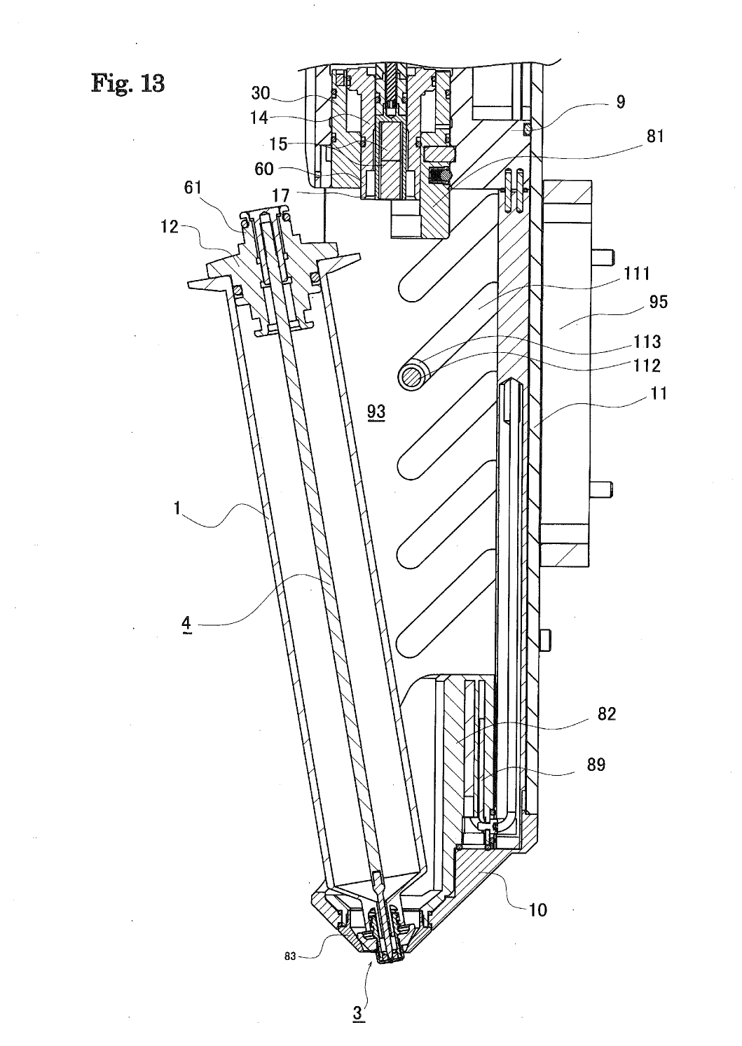

The top portion of the needle 4, namely, the upper end surface 49 of the connect sleeve 21 contacting the magnet 15 and the yoke 17 is preferably formed in a gradual R shape, namely, a spherical surface. For example, the spherical surface having a radius no greater than a length L (see FIG. 12) is formed. The length L is the length from a portion where an inner surface of a nozzle retainer plug 83 contacts an outer surface of a nozzle adapter 84 to the top portion of the needle. With this structure, when the syringe 1 or the functional cartridge 2 is tilted around the nozzle adapter 84 which contacts the nozzle retainer plug 83 as illustrated in FIG. 13 in order to remove the syringe 1 or the functional cartridge 2 from the valve body 6, the top portion of the needle 4, namely, the upper end surface 49 of the connect sleeve 21 does not interfere with the lower end of the connecting member 8 positioned at the home position, namely, the yoke 17 even when clearance between the connecting member 8 at the home position and the top portion is set narrow. Moreover, the needle 4 can be easily tilted relative to the connecting member 8 on the valve body 6 side by the spherical surface formed at the top portion of the connect sleeve 21/upper end surface 49. Further, the armature 7 and the connecting member 8 can be connected without requiring coaxial accuracy relative to the valve seat 46. In other words, even when eccentricity is generated between the needle 4 and the connecting member 8 on the solenoid 5 side, both components can be connected by the magnet 15 functioning as a coupler, and at the same time, alignment is automatically executed by a centering effect of magnetic attraction. Even when coaxial accuracy is not secured between the connecting member 8 on the valve body 6 side and the needle, a relation between the needle 4 and the valve seat 46 is not influenced. Therefore, the only condition is to provide a structure capable of securing coaxial accuracy between the needle 4 and the valve seat 46, and comprehensive coaxial accuracy is not really needed between the respective components. Even in the case where an angle of contact surface is varied, a surface attracted by the magnet 15 is prevented from uneven contact. Additionally, the syringe can be self-supported by being suspended by the magnet 15 of the connecting member 8 which works with the solenoid 5 by magnetic attraction force. Therefore, after the syringe is attached to a predetermined position, the syringe 1 or the functional cartridge 2 may not be tilted or fall even when a hand is released because the syringe can be self-supported in a state the needle 4 is attracted by the magnet 15. Further, the spherical-shaped upper end surface 49 of the connect sleeve 21 does not directly contact the magnet 15 which is relatively fragile, and contacts the yoke 17 projecting slightly higher than the magnet 15 around the magnet 15. With this structure, the relatively fragile magnet 15 is protected, and also magnetic attraction force is made to act strongly.

The coaxial accuracy between the needle 4 and the syringe 1 or the functional cartridge 2 is kept by the valve seats 46 disposed at both ends of the syringe 1 or the functional cartridge 2 and the universal adapter 12, or the valve seat 46 and the extension rod 13. On the other hand, since the solenoid 5 on the valve body 6 side is connected by the magnet 15, angle freedom is high and a structure not influenced by eccentricity of the valve body 6 can be achieved. In other words, even when misalignment or tilting occurs between the connecting member 8 on the valve body 6 side and the needle 4, coaxial accuracy can be secured between the needle 4 and the valve seat 46.

The valve stroke adjustment mechanism 50 is provided with a torque limiter. The torque limiter of the present embodiment includes, as illustrated in FIG. 5, a ball plunger 55 held at a torque limiter housing 51 provided rotatable around a micro adjustment cap 53 via a thrust bearing 52, and a recessed portion or a hole 56 provided at a torque limiter holder 54 integrated with the micro adjustment cap 53. A ball of the ball plunger 55 on the torque limiter housing 51 side is fitted into the recessed portion or the hole 56 provided on the torque limiter holder 54 side, thereby applying a constant load. The micro adjustment cap 53, torque limiter housing 51, and torque limiter holder 54 are made of aluminum for weight reduction. Therefore, a setscrew 57 made of stainless steel contacting a head portion of the stroke adjustment rod 32 is screwed into the torque limiter housing 51, and an upper stroke end of the needle 4 is defined by receiving the top portion of the stroke adjustment rod 32. Further, as the case may be, the stroke adjustment rod 32 and the torque limiter housing 51 may be integrated by fixing the stroke adjustment rod 32 to the torque limiter housing 51 with a fixing means such as a setscrew or press-fitting as illustrated in FIG. 19. In this case, there is no possibility that only the stroke adjustment rod 32 jumps out even when the micro adjustment cap 53 is removed without releasing pressure applied to the syringe 1 or the like. According to a structure in the related art in which the micro adjustment cap 53 and the stroke adjustment rod 32 are fixed, work to achieve a zero point tends to rely on sense of an operator, and the zero point cannot be correctly achieved. However, by providing the torque limiter at the valve stroke adjustment mechanism 50, the zero point can be correctly achieved by making the micro adjustment cap 53 idle when torque of a setting value or a higher value is applied. Accordingly, a desired stroke amount of the needle 4 can be correctly set by pulling up a position of the setscrew 57 by rotating the micro adjustment cap 53 so as to return by a desired amount based on the detected zero point while using a scale 58 provided at the outer peripheral surface. On the other hand, the micro adjustment cap 53 is engaged with the screw at the upper portion of the upper core 43 by screwing. Therefore, when the micro adjustment cap 53 is rotated, upward or downward movement is executed, and the position of the setscrew 57, namely, a rising end of the stroke adjustment rod 32 can be adjusted. Since the stroke adjustment rod 32 does not freely fall because of frictional force of an O-ring disposed in a space with the spring plug 45, the stroke adjustment rod 32 is held at a position abutting against the setscrew 57 by being pushed up by attraction by the solenoid 5 of the armature 7.

Meanwhile, the torque limiter holder 54 and the micro adjustment cap 53 engaged therewith by screwing are constantly pushed upward by a plurality of spring plungers 59 circumferentially disposed on the junction box 9 side. The spring plunger 59 absorbs play at the threaded portion by pushing up the micro adjustment cap 53, and further makes the micro adjustment cap 53 function as a rotation stopper by applying frictional force thereto. More preferably, as illustrated in FIG. 19, an annular anti-slip member 120 is fitted into a bottom surface of the cap 53 such that the torque limiter holder 54 is made to press the spring plunger 59 by interposing the anti-slip member 120. In this case, the micro adjustment cap 53 can be surely prevented from rotating/loosening due to vibration generated at the time of high-speed shot. As the anti-slip member 120, using packing made of material having a low friction coefficient so as to be at least less slippery than metal, for example, elastomer packing such as urethane rubber and silicone rubber is preferable. Meanwhile, the above-described valve stroke adjustment mechanism 50 is applied not limited to the valve structure of the present embodiment in which the actuator 5 side and the needle 4 side are magnetically coupled, but can be applied to any valve structure in which a stroke amount of a needle is adjusted by vertical movement generated by rotating the stroke adjustment rod 32 using a screw feed mechanism.

Here, the zero point means a state in which clearance between the needle 4 and the valve seat 46 is closed and there is no clearance between the stroke adjustment rod 32 and an upper surface of the hook 16 disposed at the hole 20 at the center of the armature 7. In this state, the armature 7 is moved upward by excitation of the solenoid 5, but the hook 16 is not pushed upward because the hook 16 is pressed down to a lowermost surface of the stroke adjustment rod 32. At the same time, in this state, the valve seat 46 contacting the tip of the needle 4 is prevented from being opened in the same manner, and discharge cannot be performed no matter how long the solenoid 5 is excited.

Further, in the case of using the solenoid 5 as the actuator, exciting force may be weakened by heat generated by the solenoid 5 depending on the using situation. As a result, the discharge amount may become unstable. Therefore, exciting force is kept constant by cooling down temperature increase of the solenoid 5 by using refrigeration fluid such as air, water, and liquid nitrogen. At this point, a temperature sensor to cope with temperature change of the solenoid 5 (not illustrated) is provided in the vicinity thereof, and an amount of air blow may be adjusted by using electro-pneumatic conversion in order to keep the temperature of the solenoid 5 constant. However, in the present embodiment, an access port for cooling air to communicate with the air passages 114a, 114b is provided in a space with the junction box 9 surrounding the coil housing 33 of the solenoid 5, and the solenoid 5 can be effectively cooled by adopting a cooling method of simply flowing compressed air around the coil housing 33.

The positioning member 14 includes, as illustrated in FIG. 7, a connecting portion 60 having a shape conforming to a shape of an end portion of the syringe 1 or the functional cartridge 2 to be attached to a lower portion thereof. Here, note that in the case of attaching the syringe 1 or the functional cartridge 2 to the valve body 6 by interposing the adapter 12 or the extension rod 13, the shape of the end portion of the syringe 1 or the functional cartridge 2 indicates a plug 61 of the adapter 12 or a plug 62 of the extension rod 13 to be a part of the syringe 1 or the functional cartridge 2. Further, note that in the case of attaching the syringe 1 or the functional cartridge 2 directly to the connecting portion 60, the shape of the end portion of the syringe 1 or the functional cartridge 2 indicates the end portion thereof. The positioning member 14 enables centering and connection of the syringe 1 or the functional cartridge 2 by fitting the plugs 61, 62 of the adapter 12 or the extension rod 13 on the syringe 1 or the functional cartridge 2 side into the connecting portion 60, and further forms a seal between junction box 9, lock-up sleeve 30, and the plugs 61, 62 of the adapter 12 or the extension rod 13 on the syringe 1 or the functional cartridge 2 side. The positioning member 14 is configured to be moved down to the syringe 1 or the functional cartridge 2 by pressure of a working gas, for example, an inactive gas such as compressed air and a nitrogen gas (hereafter simply referred to as compressed air) and to be positioned coaxially. At the same time, the positioning member 14 is pushed up to an upper limit of a movable range, thereby disconnecting the connecting portion 60 at the lower end from the plug 61 of the universal adapter 12 or the plug 62 of the extension rod 13. Further, the positioning member 14 functions to generate clearance between the yoke 17 and the universal adapter 12 or the extension rod 13 by pushing up the armature 7 to push up the connecting member 8 until the hook 16 abuts against the rod 32. In other words, the positioning member 14 of the present embodiment functions as a mechanism to attach/remove the syringe 1 or the functional cartridge 2 to/from the valve body 6 by advancing and retreating itself relative to the syringe 1 or the functional cartridge 2, a biasing mechanism to continuously push the syringe 1 or the functional cartridge 2 against the nozzle base 10, and a sealing mechanism to establish a passage to supply the air supplied via the valve body 6 into the syringe 1 or the functional cartridge 2. Of course, the respective mechanisms may be formed by separate members. The positioning member 14 of the present embodiment includes the piston 63, a piston rod 64, and the connecting portion 60 having a cylindrical shape (hereafter also referred to as a connecting port 60), and provided with a hole 28 at center thereof to allow the connecting member 8 pass through. An opening 28a on an upper side of the hole 28 is a recessed portion to house the flange 22 projecting at a center of a lower surface of the armature 7. Note that generally compressed air is used as the working gas, but if necessary, the inactive gas such as nitrogen may be used in order to prevent deterioration of solvent to be discharged.

Here, O-rings are disposed between the positioning member 14, connecting member 8, and plugs 61, 62 of the universal adapter 12 or the extension rod 13 so as to establish relations as follows.

First, in a state that the positioning member 14 is started moving downward by feeding the compressed air to push down the positioning member 14 via the air passage 114c into the space 38 in which the armature 7 and the positioning member 14 are housed, two O-rings including an O-ring 65 around a peripheral surface of the piston 63 and an O-ring 25 around a peripheral surface of the intermediate connector 18 function as seals when the positioning member 14 is moved downward such that pressure can be applied to the space 38 where the armature 7 is located. On the other hand, air inside a space 117 under the piston 63 is released outside via an access port 118 and the air passage 114d without being compressed because a valve (not illustrated) to control application of air pressure to the space 117 is in an opened state, and the positioning member 14 is moved downward by the air pressure.

Further, when the plug 61 of the universal adapter 12 or the plug 62 of the extension rod 13 is fitted into an inner peripheral surface of the connecting port 60 at the lower end of the positioning member 14 being moved down, O-rings 67, 68 around peripheral surfaces of the plugs 61, 62 contact the inner peripheral surface of the connecting port 60 and form seals in order to further push down the positioning member 14.

Moreover, when the positioning member 14 is pushed down by the supplied compressed air, the O-ring 25 around the intermediate connector 18 comes off from the hole 28 at the center of the positioning member 14. As a result, the compressed air breaks the seal at the passage communicating the space 38 on an upper portion of a cylinder portion of the lock-up sleeve 30 with the inside of the syringe 1 or the functional cartridge 2, passes through the clearance between the yoke 17 and the hole 28 penetrating the center of the positioning member 14, and flows into the syringe 1 or the functional cartridge 2. Then, while the syringe 1 or the functional cartridge 2 is being filled with the pressure, a seal to prevent air pressure from leaking outside is formed by the O-rings 67, 68 around the plug 61 of the universal adapter 12 or the plug 62 of the extension rod 13 to be fitted into the connecting port 60 of the positioning member 14.

Further, in a state that the syringe 1 or the functional cartridge 2 is pressed to the predetermined position by downward movement of the positioning member 14, namely, in the state that the needle 4 works with the armature 7 as illustrated in FIGS. 6 and 7, the O-ring 25 around the intermediate connector 18 is positioned outside the hole 28 at the center of the positioning member 14, namely, at the position not forming the seal in a space with the positioning member 14. On the other hand, the O-ring 25 is disposed to form a seal between the O-ring 65 around the piston 63 of the positioning member 14 and the inner peripheral surface of the cylinder portion of the lock-up sleeve 30 and between the inner peripheral surface of the connecting port 60 of the positioning member 14 and the O-rings 67, 68 of the plug 61 of the universal adapter 12 or the plug 62 of the extension rod 13. Therefore, even when a hook assembly, namely, the connecting member 8 (the hook 16, intermediate connector 18, and yoke 17 (including the magnet 15)) is vertically moved working with the armature 7 by excitation of the solenoid 5, the O-ring 25 around the intermediate connector 18 does not become sliding resistance and smoothens movement of the needle 4. In other words, when the needle 4 is moved, there is no influence received from sliding resistance of the O-ring 25. Therefore, the needle 4 has a structure in which operation is free from restraint of the sliding resistance, and correct operation according to excitation time of the solenoid 5 can be performed, thereby achieving correct discharging accuracy with repeatability. At the same time, the passage to supply pressure to the syringe 1 can be secured. Further, durability of the O-ring 25 is enhanced because the O-ring 25 does not contact the positioning member 14. In the case where the position of the O-ring 25 is located at a place of sliding, not only correct discharging operation cannot be performed but also wear of the O-ring 25 is accelerated because the O-ring 25 is exposed to sliding operation at every discharging (exciting operation of the solenoid 5). Therefore, O-ring 25 is worn out when operation is performed by the positioning member 14 along with removal of the syringe, and the air pressure can be hardly kept without being leaked.

On the other hand, in a process that the positioning member 14 is pushed up by the air pressure, the O-ring 25 around the intermediate connector 18 enters the inside of the hole 28 and forms a seal in the space with the positioning member 14 and blocks the passage/hole 28 communicating the space 38 in the upper portion of the cylinder portion of the lock-up sleeve 30 with the inside of the syringe. Then, the connecting port 60 at the lower end of the positioning member 14 comes off from the plug 61 of the universal adapter 12 or the plug 62 of the extension rod 13. Further, in a state that the positioning member 14 is pushed up by the air pressure up to the upper limit, a seal is formed between the lock-up sleeve 30 and the intermediate connector 18 with the three O-rings including the O-ring 65 around the peripheral surface of the piston 63 of the positioning member 14, the O-ring 66 around the peripheral surface of the piston rod 64, and the O-ring 25 around the peripheral surface of the intermediate connector 18. Meanwhile, when the air pressure having pushed up the positioning member 14 in this state is cut off, the positioning member 14 is slightly pushed back downward by force of the spring 24 via the pusher 31. However, the lower surface of the armature 7 abuts against an end surface at an uppermost level of the lock-up sleeve 30 and then the armature 7 is restrained at the position. Therefore, the three O-rings 25, 65, 66 function as resistance, thereby preventing the positioning member 14 from being moved downward/falling by its own weight.

The platform 11 of the present embodiment is formed to have a U-shaped cross section covering the three surfaces on both right and left sides and a back surface except for a front surface side where the syringe 1 or the functional cartridge 2 is inserted and ejected. With this structure, the platform 11 generally has high rigidity, and even when flushing air is applied, the platform is not expanded in the axial direction/longitudinal direction (between the junction box 9 and the nozzle base 10 receiving the valve seat assembly 3), and an applying position/target position of the liquid material such as an adhesive agent is prevented from being deviated. Moreover, since a flange portion 70 of the universal adapter 12 which is a maximum diameter portion on the syringe 1 side is housed between both right and left side walls 69 of the platform 11, the flange portion 70 is provided being surrounded by the right and left side walls 69 of the platform 11 in a manner sandwiched between both of the right and left sides. Therefore, a dimensional relation between a diameter or at least a width of the flange portion 70 of the universal adapter 12 and a width between the right and left side walls 69 of the platform 11 is set such that only small clearance not causing any trouble in inserting the syringe 1 is formed. With this structure, attachment of the syringe to the valve body 6 and positioning of the flange portion 70 in the horizontal direction are completed at the same time, and the syringe 1 can be prevented from being tilted in the horizontal direction. In the present specification, the maximum diameter portion on the syringe side or the functional cartridge side indicates a portion most projecting in a lateral width direction of the syringe 1 or the functional cartridge 2, and is not limited to the above-described flange portion 70 of the universal adapter 12. In the case where an adapter conforming to a form and each size of the syringe 1 or the functional cartridge 2 is prepared, the maximum diameter portion indicates a maximum diameter portion of each adapter, and in the case where neither the adapter 12 nor the extension rod 13 is interposed, the maximum diameter portion indicates a largest lateral width of the syringe 1 itself or the functional cartridge 2 itself. Meanwhile, adopting the platform 11 having the U-shaped cross section surrounding the three sides of the syringe 1 is preferable in the view of obtaining rigidity of the valve body 6, especially, effective rigidity to suppress displacement/deform in the axial direction, and also assisting positioning at the time of attaching the syringe to the valve body 6. However, not limited thereto, a structure in which the junction box 9 and the nozzle base 10 are connected by a tie rot may be also adopted like a frame structure disclosed in Patent Literature 1.

Further, positioning control on the back side is performed by abutting a second shoulder portion 71 above the flange portion 70 of the universal adapter 12 and a positioning shoulder portion 80 adjacent to the plug 62 at the upper end of the extension rod 13 against an inner peripheral surface on the back-side of a semicircular guide portion 81. The guide portion 81 is disposed at the lower end of the lock-up sleeve 30 and projects downward from a bottom surface of the junction box 9. In other words, a size of the positioning shoulder portion 80 of the extension rod 13 is set same as the size of the second shoulder portion 71 of the universal adapter 12. Therefore, when the syringe 1 fitted with the universal adapter 12 is inserted into the platform 11 of the valve body 6, and pushed in until the second shoulder portion 71 abuts against the inner peripheral surface on the back side of the guide portion 81 or pushed in until the positioning shoulder portion 80 of the extension rod 13 abuts against the inner peripheral surface on the back side of the guide portion 81, alignment relative to not only the platform 11 and also the positioning member 14 is substantially executed in both the horizontal and back side directions. Therefore, by moving down the positioning member 14, the third plug portion 61 of the universal adapter 12 or the plug 62 at the upper end of the extension rod 13 connected to the universal adapter 12 is fitted into the connecting port 60 at the lower portion of the positioning member 14. Then, centering and connection between the valve body 6 side and the syringe 1 side are completed at the same time. Moreover, in the case where the second shoulder portion 71 of the adapter 12 and the positioning shoulder portion 80 of the extension rod 13 are formed in the same shape and the same size, constant positioning can be executed even in the case of attaching the syringe 1 or the functional cartridge 2 having different sizes and shapes.

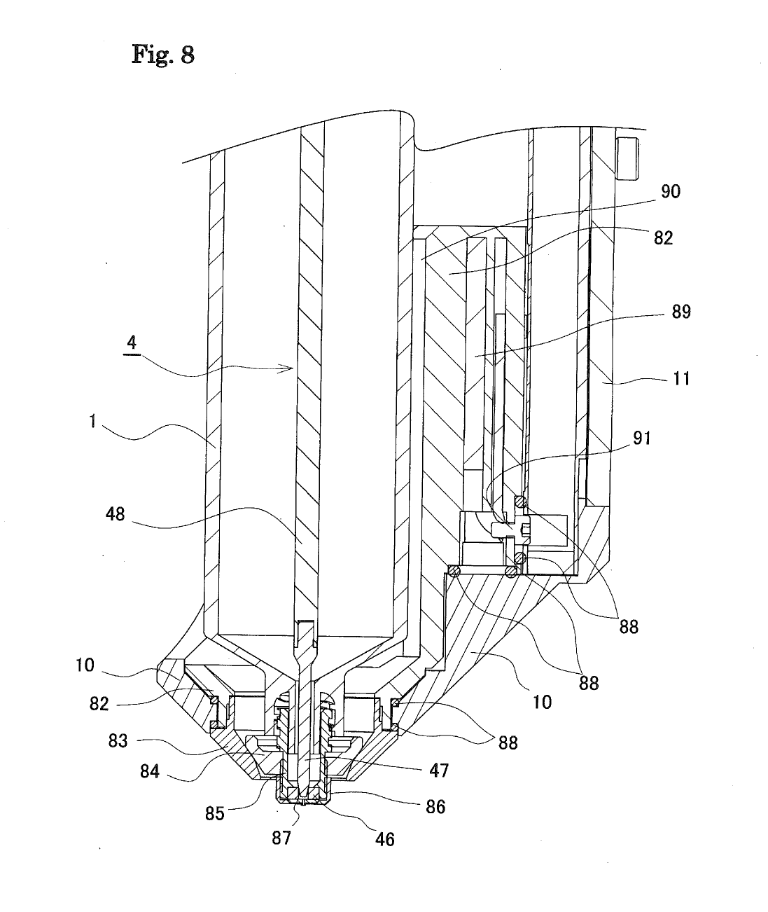

The nozzle base 10 located at the lower portion of the valve body 6 and configured to receive and hold the valve seat assembly 3 is connected to the junction box 9 by the platform 11 as illustrated in FIG. 8. The nozzle base 10 is disposed coaxially with the positioning member 14 of the junction box 9, and holds a nozzle receiver 82 and the nozzle retainer plug 83, and further defines and forms a syringe housing space 93 to house the syringe 1 or the functional cartridge 2 in a space with the junction box 9. On the other hand, the valve seat assembly 3 of the present embodiment includes a seat holder 85 having a threaded portion on an outer peripheral surface thereof, a nozzle retainer 86, the valve seat 46, a nozzle 87, and the nozzle adapter 84, and adopts a luer lock (screwing) type in which the syringe 1 or the functional cartridge 2 is fixed by screwing the threaded portion of the seat holder 85 into a female threaded portion provided at a mouth of the tip of the syringe 1 or the functional cartridge 2. The valve seat assembly 3 is disposed such that the syringe or the functional cartridge can be positioned at the predetermined position by making a tapered surface or a spherical surface of an outer surface of the nozzle adapter 84 abut against an inner surface of a tapered surface or a spherical surface of the nozzle retainer plug 83 on the nozzle base 10 side. Of course, as the case may be, luer slip (non-screwing) type can be also adopted in the valve seat assembly 3, and as far as there is at least a component capable of functioning as the valve seat 46 can be attached to the tip of the syringe 1 or the functional cartridge 2, not all of the above-described components are not needed.

A ball 88, preferably, a ceramic ball is disposed between the nozzle base 10 and nozzle receiver 82 so as to form a structure providing a heat insulation effect by making a heater 89 contact the valve body 6 (nozzle base 10) only at a point. Further, clearance 90 is set between the nozzle receiver 82 and the syringe 1 or the functional cartridge 2 such that heat of the heater 89 included in the nozzle receiver 82 is hardly transmitted through a peripheral wall of the syringe 1 or the functional cartridge 2. Therefore, heat of the heater 89 is hardly transmitted from the nozzle base 10 to the platform 11 and junction box 9 sides, and normally heat is transmitted to the nozzle retainer plug 83 and the nozzle adapter 84 from the nozzle receiver 82 in which a cartridge heater 89 and a temperature sensor 91 are included in, and then transmitted to the valve seat assembly 3 at the tip of the syringe 1 or the functional cartridge 2. Controlling temperature of the liquid material filled inside the syringe 1 or the functional cartridge 2 is necessary to stabilize viscosity of the liquid material, but heating up an entire portion of the syringe 1 or the functional cartridge 2 may give heat damage to the liquid material. Therefore, the valve of the present embodiment normally heats the nozzle 87 at the tip portion of the syringe 1 or the functional cartridge 2 in a concentrating manner. However, there may be a case where the entire portion of the syringe 1 or the functional cartridge 2 is needed to be heated depending on the liquid material. In this case, a cylindrical heat transmission tube 92 made of material having excellent heat conductivity is fitted into the syringe 1 or the functional cartridge 2 so as to fill the clearance 90 between the nozzle receiver 82 and the syringe 1 or the functional cartridge 2. Then, heat of the heater 89 is transmitted via the heat transmission tube 92 to the syringe 1 or the functional cartridge 2 in a range surrounded by the heat transmission tube 92, and temperature can be easily adjusted in a wide area of the syringe 1 or the functional cartridge 2.

Here, in the case where fastening of the valve seat assembly 3 to the syringe 1 or the functional cartridge 2 is loose when the valve seat assembly 3 is attached to the syringe 1 or the functional cartridge 2, liquid leakage may occur at the fitted portion and there may be risk of the liquid dropping on a product to which the liquid material is actually discharged. Therefore, the present embodiment provides a structure in which in the case where the valve seat assembly 3 is not perfectly attached to the tip of the syringe 1 or the functional cartridge 2, attachment to the valve body 6 is not accepted, and controlling an attachment state of a component to be attached to the syringe 1 or the functional cartridge 2 is facilitated. In other words, the valve of the present embodiment has the structure in which the syringe 1 or the functional cartridge 2 mounted with the valve seat assembly 3 and the universal adapter 12 cannot be inserted into the space below the positioning member 14, namely, the syringe housing space 93 in the case where an entire length L is longer than an axial-direction effective length of the syringe housing space 93 of the valve body 6 as illustrated in FIG. 12. The length L is an entire length when the valve seat assembly 3, needle 4, and if necessary, the universal adapter 12 or the extension rod 13 are attached to the syringe 1 or the functional cartridge 2 (length from where the inner surface of the nozzle retainer plug 83 contacts the outer surface of the nozzle adapter 84 to the top portion of the needle). Here, the axial-direction effective length of the syringe housing space 93 indicates a distance/length up to the lower end of the connecting port 60 of the positioning member 14 which is in a state pushed up to an uppermost end position from the position of the nozzle retainer plug 83 (predetermined position) to which the valve seat assembly 3 is pressed. More specifically, in the present embodiment, in the case where clearance between the valve seat assembly 3 and the syringe 1 or the functional cartridge 2 at the time of attaching is not smaller than a predetermined value, for example, 2 mm, the structure is made such that the syringe 1 or the functional cartridge 2 cannot be inserted because the positioning member 14 hits the universal adapter 12. With this structure, liquid leakage caused by insufficient fastening between the valve seat assembly 3 and the syringe 1 or the functional cartridge 2 is prevented. In other words, in the case where fastening between the valve seat assembly 3 and the syringe 1 or the functional cartridge 2 is loose, the entire length L on the syringe side becomes longer than a maximum dimension in the state that the positioning member 14 is pushed up. Therefore, the syringe 1 or the functional cartridge 2 cannot be housed into the syringe housing space 93 of the valve body 6. Of course, depending on the stroke adjustment amount of the needle 4, for example, when the stroke is narrowed at the time of discharging a small amount, there may be a case where the axial-direction effective length inside the syringe housing space 93 is made shorter than the predetermined value because of the lower end portion of the yoke 17 connected to the hook 16 pushed by the tip of the stroke adjustment rod 32. In this case, such a situation can be resolved by, for example, rotating the micro adjustment cap 53 in the opposite direction and retracting the rod 32 at the time of attaching the syringe.

According to the present embodiment, the syringe 1 or the functional cartridge 2 to be inserted into the syringe housing space 93 is connected to the junction box 9 of the valve body 6 by fitting, into the connecting port 60 of the positioning member 14, the adapter 12 or the extension rod 13 fitted into the syringe 1 or the functional cartridge 2 side. In this case, the adapter 12 or the extension rod 13 can be attached to the syringe 1 or the functional cartridge 2 with a fingertip operation when the size is made containable inside the syringe housing space 93 by standardizing a shape of an end portion on a side of the adapter 12 or the extension rod 13 to be fitted into the connecting port 60, and by forming a shape of an end portion on the other side conforming to the shape of the connecting target such as the syringe 1, functional cartridge 2, or adapter 12. Of course, when the syringe 1 or the functional cartridge 2 is connected to the valve body 6, namely, connected to the positioning member 14 of the junction box 9, the adapter 12 or the extension rod 13 is not necessarily interposed, and direct connection may also be possible by forming the shapes of end portions of the connecting portion 60 of the positioning member 14 and the syringe 1 or the functional cartridge 2 in a shape conforming to each other.

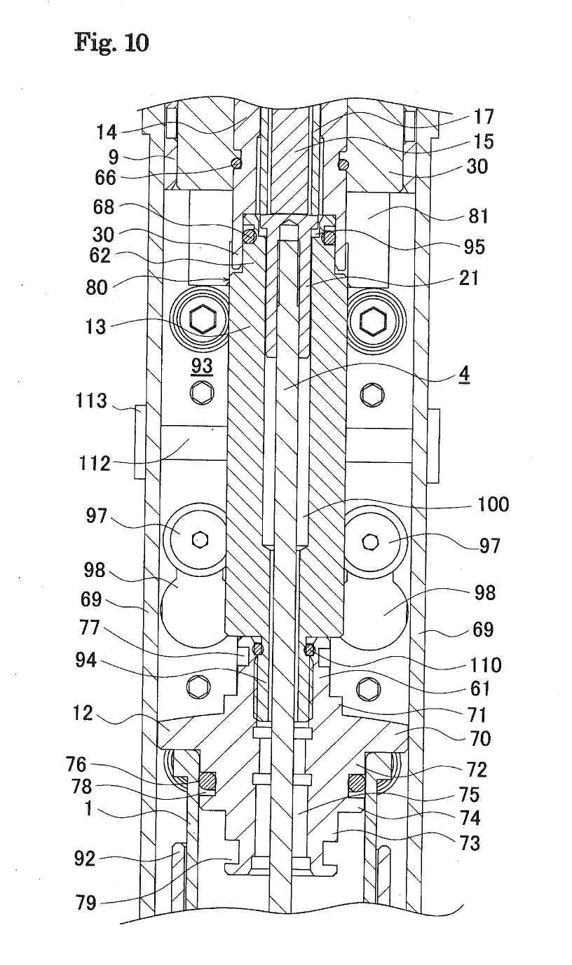

The adapter 12 may be prepared to conform to each size of the syringe 1 or each shape and size of the functional cartridge 2, but in the case of the present embodiment, all of the syringes can be attached by using just one universal adapter 12 capable of conforming to four kinds of syringes, such as syringes of 55 cc, 30 cc, 10 cc, and 5 cc which are most distributed syringes out of the those distributed in the market. Of course, the adapter 12 may conform to the functional cartridge 2 as well. As illustrated in FIGS. 7 and 10, the universal adapter 12 is formed as one integrated block including: the flange portion 70 contacting an opening edge of the syringe 1 of 55 cc or 30 cc; a first plug portion 72 adjacent to a lower portion of the flange portion 70 and to be fitted into an inner peripheral surface of a syringe of 55 cc or 30 cc: a second plug portion 73 located in an area on a tip side lower than the first plug portion 72 and to be fitted into the inner peripheral surface of a syringe of 10 cc; a first shoulder portion 74 contacting an opening edge of the syringe of 10 cc; the second shoulder portion 71 contacting an opening edge of a syringe of 5 cc on an opposite side interposing the flange portion 70 as a boundary; and the third plug portion 61 to be fitted into an inner peripheral surface of the syringe of 5 cc (plug to be fitted into the connecting port 60 of the positioning member 14), and further is provided with a hole 75 which allows the needle 4 to pass though centers of the respective plug portions 61, 72, 73 and also can be fitted with the extension rod 13. In the case of the present embodiment, an entrance portion of the hole 75 is formed as a threaded hole. Here, when the syringe 1 of 50 cc, 30 cc, or 10 cc is used, the third plug portion 61 for the syringe of 5 cc exposed outside the syringe 1 on the other side is utilized as a connecting means to be fitted into a cylindrical portion for fitting provided at the lower end of the positioning member 14, namely, the connecting port 60. In other words, an inner diameter of the connecting port 60 is formed same as an inner diameter of the syringe for 5 cc. Also, the diameter of the second plug portion 73 for the syringe of 10 cc is formed same as the inner diameter of the connecting port 60. Therefore, even in the case of using any one of the third plug portion 61 for the syringe of 5 cc and the second plug portion 73 for the syringe of 10 cc on the opposite side, the universal adapter 12 is utilized as the connecting means to be fitted into the connecting port 60 at the lower end of the positioning member 14, and further, by fitting the extension rod 13, the universal adapter 12 is connected to the connecting port 60 at the lower end of the positioning member 14 by fitting via the extension rod 13. Note that the grooves 77, 78, 79 are provided at the first to third plug portions 61, 72, 73 respectively to mount the O-rings 67, 76, and are used as a structure capable of forming a seal by setting an O-ring conforming to an inner diameter size of a corresponding syringe. Additionally, only very small clearance is set between the flange portion 70 of the universal adapter 12 and both right and left side walls 69 of the platform 11 so as not cause any problem in dimensional relation at the time of attaching the syringe. Therefore, when the syringe 1 is attached to the valve body 6, the platform 11 of the valve body 6 prevents the syringe 1 from being tilted in the horizontal direction.

Here, a position of the second shoulder portion 71 or the second plug portion 73 above the flange portion 70 is determined by being abutted against the inner peripheral surface of the guide portion 81 on the back side at the lower end of the lock-up sleeve 30. In other words, the second shoulder portion 71 or the second plug portion 73 is used not only to determine the position at the time of being fitted into the syringe of 5 cc but also utilized as a sign to determine the position on the back side at the time of attaching the syringe 1 to the valve body 6. Meanwhile, according to the present embodiment, the second shoulder portion 71 is disposed on the universal adapter 12 side or the second plug portion 73 is utilized to function as the sign to determine the position on the back side by abutting the second plug portion 73 against the inner peripheral surface of the guide portion 81 on the back side at the lower end of the lock-up sleeve 30. However, not particularly limited thereto, as the case may be, a semicircular-shaped projection (not illustrated) projecting toward the universal adapter 12 side may be formed on the lock-up sleeve 30 side so as to function as a sign to determine a position of the third plug 61. In this case, a corresponding recessed portion is needed to be formed on the second plug portion 73 side. Further, there may be a structure in which the position on the back side is determined by a part of the syringe 1 or the functional cartridge 2 directly abutting against a sort of positioning means on the valve body 6 side. Additionally, the guide portion 81 is neither needed to be integrally formed with the lock-up sleeve 30 nor needed to be formed in the semicircular shape. The guide portion 81 can be structurally integrated with the junction box 9, for example. However, in this case, an outer shape of the adapter 12 or the extension rod 13 is needed to be enlarged, and it can be hardly said functional. On the other hand, in the case of integrally forming the semicircular-shaped guide portion 81 with the lock-up sleeve 30 in a manner projecting from the junction box, the outer shape of the adapter 12 or the extension rod 13 can be formed minimum, which is therefore functional. Further, since the guide portion 81 functions as a handle at the time of rotating the lock-up sleeve 30 in order to remove the lock-up sleeve 30 from the junction box 9, the lock-up sleeve 30 can have a structure easy to be gripped with a hand.

Further, the size of the valve body 6 may be designed for each size of the syringe, but in order to standardize the valve, the size of the valve body 6 is designed conforming to a largest syringe size which meets a purpose of use, for example, conforming to the outer diameter/length of the syringe of 55 cc in the present embodiment. Therefore, in the case of attaching the syringe of 55 cc having the largest syringe size, the syringe can be attached to the valve body 6 only by fitting the plug of the universal adapter 12 for the syringe of 55 cc, namely, the first plug portion 72 into an opening of the syringe and then fitting the plug for the syringe of 5 cc projecting on the other side, namely, the third plug portion 61 into the positioning member 14. But, in the case of using the syringe of 30 cc, 10 cc, or 5 cc smaller than the available largest syringe size, the length of the syringe is shorter than the length supposed in the valve body 6. Therefore, preferably, the length of the syringe is adjusted by utilizing the extension rod 13 to enable the syringe 1 to be fixed.

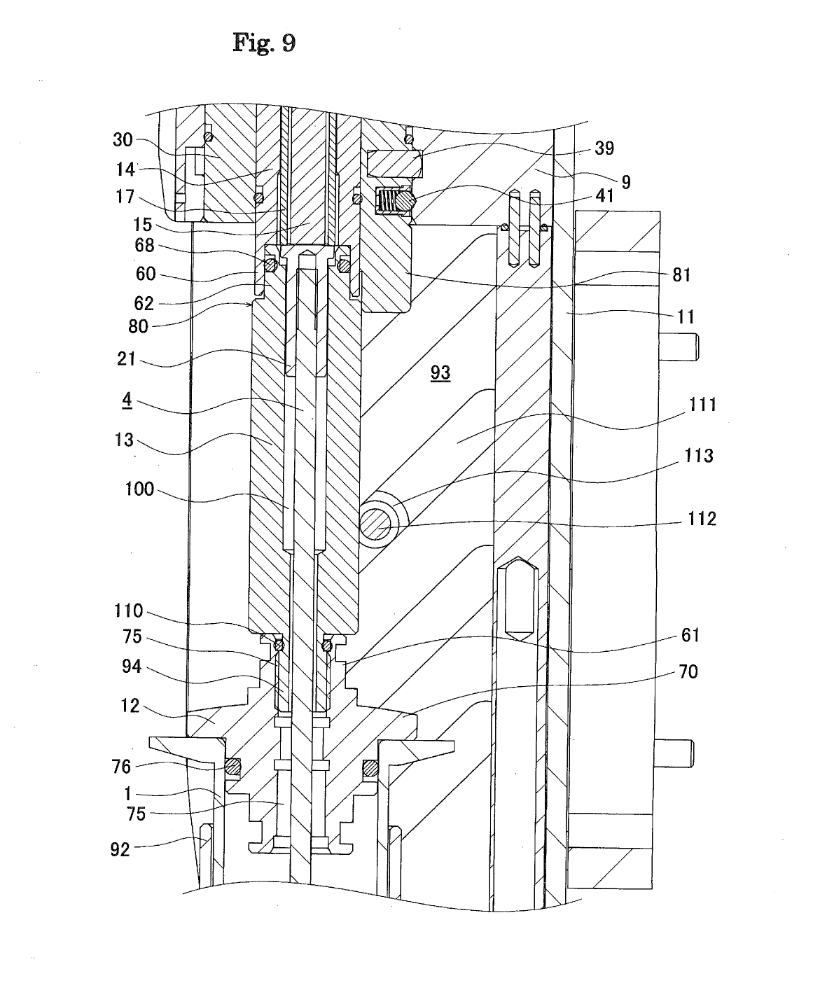

As illustrated in FIGS. 9 and 10, each extension rod 13 for each of the three syringes of 30 cc, 10 cc, and 5 cc includes, at the lower end thereof, an O-ring 110 and a plug 94 to be fitted into a hole 75 at a center of the universal adapter 12, and also includes, at the upper end thereof, the O-ring 68 and the plug 62 which can be fitted into the connecting port 60 at the lower end of the positioning member 14. Further, a hole 95 at the center of each extension rod 13, in which the needle 4 passes through, is disposed such that a space where the connect sleeve 21 can move is formed in the vicinity of an upper opening end thereof. Each extension rod 13 has a different length corresponding to each kind of syringe, but sizes of other structures, such as the plug portions at both ends and the hole 95 at the center in which the needle 4 passes through, are the same.

Meanwhile, preferably, each of the top portions of the third plug portion 61 of the adapter 12 to be fitted into the connecting port 60 at the lower end of the positioning member 14, the plug 62 of the extension rod 13, and the functional cartridge 2 in the case of directly being connect to the connecting port 60 is formed in a gradual R shape, namely, a spherical surface same as the upper end surface 49 of the connect sleeve 21. For example, the spherical surface having a radius no greater than a length L (see FIG. 12) is formed. The length L is the length from a portion where the inner surface of a nozzle retainer plug 83 contacts the outer surface of a nozzle adapter 84 to the top portion of the needle. With this structure, when the syringe 1 or the functional cartridge 2 is tilted around the nozzle retainer plug 83 at the time of attaching the syringe 1 or the functional cartridge 2 to the valve body 6 or in order to remove the same from the valve body 6 as illustrated in FIG. 13, there is a less possibility that each of the top portions of the third plug portion 61 of the adapter 12, the plug 62 of the extension rod 13, and the functional cartridge 2 interferes with the lower end of the connecting member 8 positioned at the home position even when clearance between the connecting member 8 positioned at the home position and each of the top portions is set narrow. Of course, as described above, each of the top portions of the third plug portion 61, etc. is preferably formed in a gradual R shape, namely, a spherical surface same as the upper end surface 49 of the connect sleeve 21, but this is not a prerequisite condition. For example, in the case where positioning is performed by making the tip of the connecting port 60 abut against the second shoulder portion 71 of the adapter 12 or the like, a height to each of the top portions of the third plug portion 61 of the adapter 12, the plug 62 of the extension rod 13, the functional cartridge 2 is set short. With this structure, each of the top portions does not interfere with the yoke 17 on the connecting member 8 side and the connecting port 60 at the lower end of the positioning member 14 at the time of attaching the syringe 1 or the like into the syringe housing space 93 of the valve body 6.

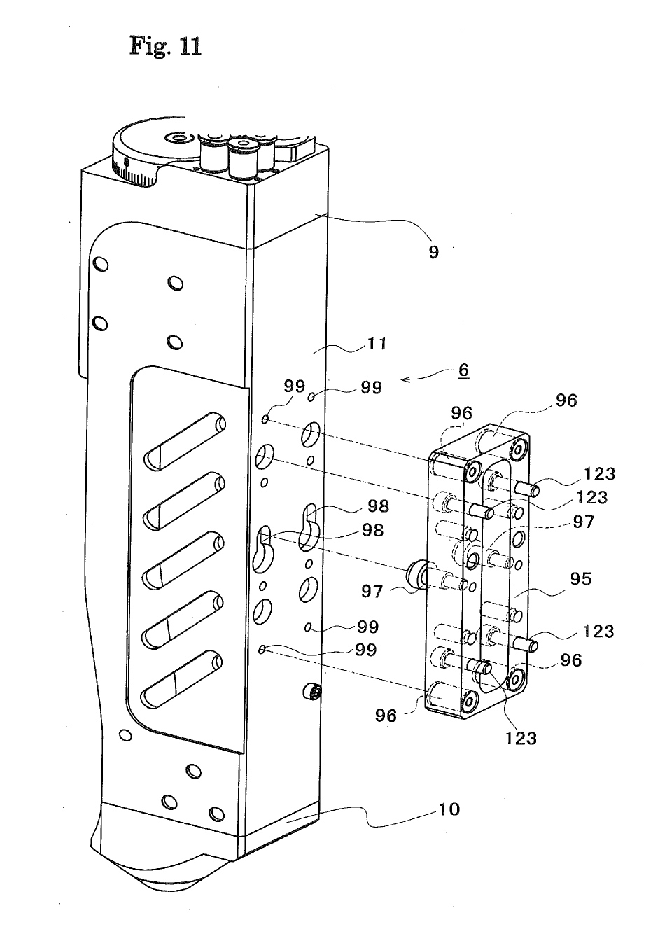

By the way, the valve (liquid material discharge device) according to the present invention is frequently used by being mounted on an automatic machine such as a robot. In this form of use, in the case where teaching is incorrectly set for a Z-axis moving amount, there may be a possibility that a member on a target side to which liquid material is discharged/applied is damaged by Z-axis (vertical-axis) movement of the robot causing the valve body 6 to collide against the member in the Z-axis direction. Therefore, in the case of the present embodiment, a bracket 95 to mount the valve body 6 on the automatic machine (robot), a wall, etc. is provided at the back surface side of the platform 11 as illustrated in FIG. 11. This bracket 95 includes ball plungers 96 at four corners of a surface facing the valve body 6 and, further includes, at an almost center thereof, a hook 97 covered with an insulation sleeve in order to be connected to the valve body 6 while keeping a distance. On the other hand, a bell-shaped hole 98 is provided on the platform 11 side as a hole formed by connecting a large hole to a small long hole, and the hook 97 is inserted from a lower hole of the bell-shaped hole 98 and slid up, and then a shaft portion of the hook 97 is passed through the small long hole on an upper side, thereby engaging the platform 11 with the bracket 95 while keeping a constant distance between the bracket 95 and the valve body 6. With this structure, when the hook 97 is engaged with the bell-shaped hole 98, balls of the ball plungers 96 at the four corners of the bracket 95 match the facing holes 99 of the platform 11 and fixed in a removable manner at the same time. Therefore, the bracket 95 provides heat insulation and a buffer effect in a space with the valve body 6 in the event of collision in the Z-axis (longitudinal direction/axial direction of the valve body 6). In other words, when torque of a predetermined value or higher between the valve body 6 and the bracket 95 supporting the valve body 6 is applied in the Z-axis direction by collision in the Z-axis direction against the member on the target side to which the liquid material is discharged/applied, the ball plunger 96 functions as a torque limiter and is configured to come off in the vertical direction. Therefore, the valve body 6 is prevented from being damaged by unexpected movement of the robot. Further, heat transmission between the valve body 6 and a member/robot on which the valve body is mounted can be suppressed by four points contact by the ball plungers 96 and contact by the hook 97 interposing the insulation sleeve. Moreover, the valve can be mounted without deforming the platform 11 side regardless of flatness of the member on which the valve is mounted such as the automatic machine and the wall. Note that the bracket 95 is attached to the automatic machine (robot) or the like with a screw 123.

According to the liquid material discharge device thus configured, a controlled amount of the liquid material can be discharged only by setting, to the valve body 6, the syringe 1 or the functional cartridge 2 preliminarily attached with the needle 4 and the valve seat assembly 3. In the following, a description will be mainly provided for a case of using the syringe 1.

First, a procedure to attach the syringe 1 to the valve body 6 will be described. The valve seat assembly 3 is attached to the tip of the syringe 1, and the adapter for a rear end opening such as the universal adapter 12 is fitted. Then, the needle 4 is inserted into the syringe 1 from the hole 75 at the center of the universal adapter 12 (refer to FIG. 1). Here, in the case where a type of the syringe 1 to be used is for small amount such as the syringe of 5 cc, 10 cc, or 30 cc, the syringe is shorter than the maximum length applicable to the valve body 6. Therefore, the length is adjusted by using the extension rod 13 such that the syringe 1 can be fixed (refer to FIG. 14). The universal adapter 12 of the present embodiment has a structure applicable to the four kinds of syringes of 55 cc, 30 cc, 10 cc, 5 cc which are most distributed syringes out of many kinds of syringes distributed in the market. Therefore, all of the syringes can be attached using only one adapter 12 by changing a fitting direction of the adapter 12 and adopting an appropriate extension rod 13. Note that the nozzle 87 and the nozzle retainer 86 of the valve seat assembly 3 can be fitted through the nozzle retainer plug 83 after the syringe 1 is attached to the valve body 6.

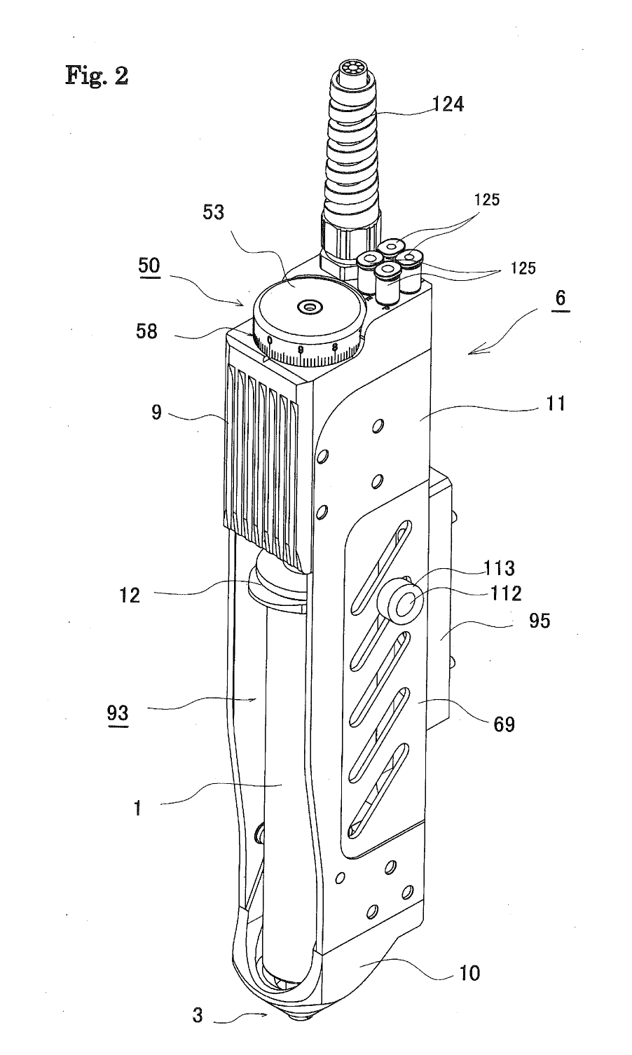

Next, as illustrated in FIG. 13, the syringe 1 inserted with the needle is obliquely inserted from the opening on a front surface of the valve body 6 to the nozzle retainer plug 83 of the valve body 6, and the nozzle adapter 84 portion at the tip of the syringe 1 is housed inside the nozzle retainer plug 83 of the valve body 6. Then, the syringe 1 is set upright centering a portion where the inner surface of the nozzle retainer plug 83 contacts the outer surface of a nozzle adapter 84, and housed inside the syringe housing space 93 (refer to FIG. 2). At this point, the valve body 6 has the positioning member 14 returned to the standby position to be ready for insertion of the syringe 1. Therefore, the connecting port 60 portion at the lower end of the positioning member 14 is pulled inside the lock-up sleeve 30, and the syringe housing space 93 having a prescribed height is formed below positioning member 14. Here, when the syringe can be attached into the valve body 6, the entire length of the syringe side is within the prescribed value. Therefore, liquid leakage caused by insufficient fastening between the syringe 1 and the valve seat assembly 3 is prevented from occurrence. In contrast, in the case where the entire length of the syringe side is not within the prescribed value, the positioning member 14 collides against the universal adapter 12 and the syringe 1 cannot be inserted.

As illustrated in FIG. 5, the syringe 1 housed inside the syringe housing space 93 is pushed in up to an abutting surface of the lock-up sleeve 30 of the valve body 6, more specifically, pushed toward the guide portion 81 until the second shoulder portion 71 of the universal adapter 12 or the positioning shoulder portion 80 of the extension rod 13 abuts against the guide portion 81, thereby automatically performing positioning of the syringe relative to the valve body 6. In other words, in the state that the second shoulder portion 71 of the universal adapter 12 or the positioning shoulder portion 80 of the extension rod 13 abuts against the guide portion 81 of the lock-up sleeve 30, the positioning member 14, universal adapter 12 or the extension rod 13, also the needle 4, and the syringe 1 are concentrically disposed. At this point, the connect sleeve 21 is attracted by the magnet 15 of the connecting member 8 and the yoke 17 on the facing valve body 6 side. Therefore, the connect sleeve 21 is connected at a predetermined position just by being set close, and the syringe 1 does not fall outside the valve body 6 even when a hand is released. Moreover, since the solenoid 5, armature 7, and connecting member 8 are included in the valve body 6 and the positional relation between these components is fixed, there is no need to perform delicate re-adjustment which may occur at the time of changing the syringe 1. Meanwhile, in the case of using the functional cartridge 2 or the like not limited to the syringe 1, the situation is the same, and the needle 4 is inserted into the functional cartridge 2, or if necessary, the needle 4 is inserted after the extension rod 13 is fitted into the functional cartridge 3, and further the nozzle seat assembly 3 is attached to the tip of the functional cartridge 3. After that, the functional cartridge is attached to the valve body 6.

After completion of positioning of the syringe 1 to the valve body 6, flushing air having pressure higher than air pressure at the time of discharging the liquid material filled inside the syringe is applied into the lock-up sleeve 30 and to the space 38 above the piston 63 of the positioning member 14, thereby moving down the positioning member 14. At this point, the two O-rings including the O-ring 65 around the peripheral surface of the piston 63 and the O-ring 25 around the peripheral surface of the intermediate connector 18 function as seals to move down the positioning member 14, thereby achieving to apply pressure to the space 38 in which the armature 7 is located. Meanwhile, compressed air in the space 117 below the piston 63 of the positioning member 14 is released outside from the air passage 114d without being compressed because the valve (not illustrated) to control air pressure application to the space 117 is set to an opened state. Therefore, the positioning member 14 is smoothly moved down without resistance. By downward movement of the positioning member 14, the third plug portion 61 of the universal adapter 12 or the plug 62 at the upper end of the extension rod 13 connected to the universal adapter 12 is fitted into an empty place/connecting port 60 at the lower portion of the positioning member 14. Then, when the O-rings 67, 68 around the peripheral surfaces of the same plugs 61, 62 and the inner peripheral surface of the connecting port 60 of the positioning member 14 slide each other, centering and connection between the valve body 6 side and the syringe 1 side are completed at the same time. Further, the third seal needed to further push down the positioning member 14 is formed. Subsequently, when the positioning member 14 is moved downward further, the O-ring 25 sealing the hole 28 around the peripheral surface of the intermediate connector 18 comes off. Therefore, the air supplied to the space 38 above the piston 63 leaks into the syringe via the hole 28 and the hole 75 of the universal adapter 12 (hole 100 of the extension rod 13 depending on the case). By this, the positioning member 14 is pushed down further while the syringe is filled with the compressed air.

Further, when a ceiling surface of the connecting port 60 of the positioning member 14 being moved downward abuts against the upper end surface of the plug 61 of the universal adapter 12, the entire syringe is pushed down, and while the inner peripheral surface of the nozzle retainer plug 83 of the valve body 6 is pressed against the outer peripheral surface of the nozzle adapter 84 in a close contact state, the syringe position is forcibly moved to the proper predetermined position. At the same time, the needle 4 is also pushed down to the seat 46 made of tungsten carbide at the valve seat assembly 3 and brought into the close contact state. In this manner, the syringe 1 (or functional cartridge 2) is set to the predetermined position. Further, the O-ring 76 attached to the universal adapter 12 and sealing the syringe 1 is pushed upward by sufficient air pressure applied into the syringe, and the positioning member 14 is stopped in a state of contacting the upper surface of the universal adapter 12. In other words, afterward also, the syringe 1 or the functional cartridge 2 is continuously pushed against the valve seat assembly 3 and held at the predetermined position by the positioning member 14 to which downward force is constantly applied by the air pressure application to discharge the liquid material. Therefore, the discharge amount is prevented from fluctuating due to changes of the position of the syringe 1 and a movable area of the needle 4 during liquid material applying operation afterward.

After completion of setting the syringe 1 to the predetermined position, the air pressure applied into the syringe via the space 38 inside the cylinder above the piston 63 of the positioning member 14 is switched by a control unit not illustrated to a pressure suitable for discharging the liquid material to be ready for discharging/applying operation for the liquid material. Subsequently, the valve stroke adjustment mechanism 50 is adjusted, if necessary, such that the movable amount/stroke amount of the needle 4 is suitable for the amount of the liquid material to be discharged, and further the discharging period is set. After that, when the solenoid 5 is excited, the armature 7 is attracted, and the needle 4 is moved up a moment later than movement of the armature 7, thereby opening the nozzle 87 to discharge the liquid material filled inside the syringe for a period in which the needle 4 is held up. At this point, the armature 7 is separated from the connecting member 8. Therefore, force of the spring 24 to push back the needle 4 to the home position via the pusher 31 is loaded to the hook 16 on the needle 4 side but not loaded to the armature 7 side. Therefore, attraction delay due to the spring load can be reduced at the beginning of excitation of the solenoid 5. Moreover, only the armature 7 is attracted along with excitation without receiving a strong load of the spring 24 to push back the needle 4 to the home position at the beginning of excitation, and the needle 4 is pulled up after the armature 7 starts moving working with the connecting member 8. Therefore, an initial pull-up load of the valve is reduced, and at the same time, an actual open period of the valve becomes shorter than the excitation time of the solenoid 5. As a result, discharging can be performed even in a short period less than 1 ms. Furthermore, the member driven by the solenoid 5/connecting member 8 on the valve body 6 side, and the needle 4 on the syringe 1 side are in the relation of being magnetically coupled with the magnet 15 and working together, and straightforwardness of the needle which independently keeps coaxial accuracy inside the syringe 1 is ensured. Therefore, the needle is prevented from being rotated due to eccentricity at every attraction even though coaxial accuracy is not sufficiently secured between the solenoid 5 and the needle 4. Note that the needle 4 is constantly pressed by the spring 24 via the pusher 31 during the liquid material discharging operation, and even in the case of trying to remove the syringe 1, the syringe 1 can be hardly removed because of force of the spring 24.

Further, in the case where the syringe 1 is changed or the syringe 1 is removed and refilled with the liquid material and then attached again, the operation is performed by applying air pressure to the space 117 below the piston 63 of the positioning member 14 and moving up the positioning member 14. The connecting port 60 is separated from the third plug of the universal adapter 12 along with upward movement of the positioning member 14, thereby releasing the syringe 1 from restraint by the positioning member 14. After that, the positioning member 14 is moved up until the hook 16 abuts against a bottom portion of the valve stroke adjustment rod 32. Therefore, the connecting member 8 is pulled up by the armature 7 being pushed up slightly higher than the standby position, and the needle magnetically coupled is also pulled up along with this movement. However, the magnetic coupling with an attraction surface in the coaxial direction is strong, but magnetic coupling is relatively weak against lateral sliding force. Therefore, the syringe 1 can be easily tilted by pulling the syringe, and the syringe 1 can be easily removed from the valve body 6. Then, a new syringe or the refilled syringe can be attached in accordance with the above-described procedure.

Note that there may be a case where the syringe 1 cannot be easily pulled out of the syringe housing space 93 by gripping the syringe 1 in the case where magnetic coupling between the needle 4 and the connecting member 8 is strong. Accordingly, preferably, an ejection rod 112 passing through the syringe housing space 93 is inserted using a window 111 formed obliquely on a side surface of the platform 11 for weight reduction and enabling confirmation of remaining amount of content/liquid material inside the syringe 1, and the syringe 1 inside the syringe housing space 93 is pushed out by the rod 112 by moving the rod 112 along the window 111 to the front side. In this case, the more upper side of the syringe 1 is pushed, the more easily syringe 1 can be tilted and removed. The rod 112 may be inserted from the window 111 to the back of the syringe 1, if necessary, or may be always disposed at the syringe housing space 93. For example, as illustrated in FIGS. 1 and 2, rollers 113 provided with anti-slip flanges may be fitted into both ends of the ejection rod 112 which penetrates the syringe housing space 93 and projects from the windows 111 of the both side walls of the platform 11. With this structure, the ejection rod 112 may be slidably supported without falling by utilizing the windows 111 of both side walls. In this case, when the syringe 1 is set inside the syringe housing space 93, the ejection rod 112 is moved automatically contacting the back portion of the syringe 1 so as to be ready for ejection. Meanwhile, according to the present embodiment, in the case where the valve body 6 is disposed in the vertical direction and mounted on a robot or the like, the window 111 is disposed in a manner inclined downward to the front side and the rod 112 is moved to the front side by its own weight. But, not limited thereto, the present embodiment can be implemented in the case where the window 111 is disposed in the horizontal direction, and depending on the situation, the window 111 may be disposed in a manner inclined downward to the back side, and the rod 112 may be moved to the back side (backward direction of the syringe housing space 93) by its own weight. Anyway, in the case of attaching the syringe 1, functional cartridge 2, or extension rod 13 by moving the rod 112 to the front side of the syringe housing space 93, the extension rod 13 is pushed from the back side so as to be tilted to the front side around the portion where the nozzle retainer plug 83 and the nozzle adapter 84 contact. Then, the syringe 1 or the like can be ejected outside the syringe housing space 93.

In the case of removing, from the junction box 9, the lock-up sleeve 30 together with the positioning member 14, armature 7, and connecting member 8 supported by the lock-up sleeve 30 for maintenance or the like, the components can be removed from the inside of the junction box 9 by oppositely rotating the lock-up sleeve 30 in a circumferential direction toward the vertical groove portion 40gv of the L-shaped groove 40g so as to separate the dowel 39 from the dowel hole 40, and further moving the lock-up sleeve 30 inside the L-shaped groove 40g to be placed at the vertical groove portion 40gv of the L-shaped groove 40g. At this point, the lock-up sleeve 30 can be pulled out with the hand, but it takes time because the lock-up sleeve 30 cannot be easily removed due to sliding resistance of the O-ring. However, in the valve according to the present invention, the lock-up sleeve 30 can be pushed out from the junction box 9 in a moment by applying the flushing air via the air passage 114c to push down the syringe to the predetermined position, utilizing action to push down the positioning sleeve by the pressure of the flushing air. Further, since the lock-up sleeve 30 can be removed from the junction box 9 together with the positioning member 14, armature 7, and connecting member 8, maintenance can be easily performed by disassembling the members into respective components. Additionally, after maintenance of the components, the components are reassembled into the lock-up sleeve 30, and the lock-up sleeve 30 is rotated to the dowel hole. Then, the lock-up sleeve 30 is fixed to the junction box 9 by the dowel being fitted into the dowel hole.

Meanwhile, in a state that the positioning member 14 is pushed up by the air pressure, the seal is formed between the lock-up sleeve 30 and the intermediate connector 18 by the three O-rings including the O-ring 65 around the peripheral surface of the piston 63, the O-ring 66 around the peripheral surface of the piston rod 64, and the O-ring 25 around the peripheral surface of the intermediate connector 18. Therefore, even when the positioning member 14 is made to a standby state by releasing the air pressure after the positioning member 14 is pushed up to the upper end, the positioning member 14 may be slightly pushed back downward by the force of the spring 24 via the pusher 31, but is prevented from falling any further by its own weight because of the resistance of the three O-rings. On the other hand, the lower surface of the armature 7 abuts against the upper end surface 49 of the lock-up sleeve 30, and the armature 7 is restrained at the position by attraction force of the magnet 42. In this state, in the case where the compressed air is fed to the space 38 where the armature 7 is disposed, the positioning member 14 starts moving downward.

Further, in the valve according to the present invention, there may be a case where liquid material applying operation is performed manually by holding the valve body 6, but generally the valve is mounted on the robot or the like and a predetermined amount of the liquid material is discharged to a target place. Therefore, the valve can be easily mounted on the robot or the like with a fingertip operation by inserting the hook 16 portion of the bracket 95 preliminarily fixed to the robot into the larger hole in the bell-shaped hole 98 on the back surface of the platform 11, and then pushing down the valve body 6.

Meanwhile, the above-described embodiment is an example of preferable embodiments of the present invention, but the present invention is not limited thereto, and various modifications can be made within a scope without departing from the gist of the present invention. For example, according to the above-described embodiment, the description has been mainly given for the example of a syringe included in the discharge device in which the syringe 1 filled with the liquid material is attached to the valve body 6 for use, but not limited thereto, various kinds of modules can be attached, and the present invention can be also used as a liquid material supply system in various forms, for example, a type in which liquid material is supplied with pressure from a pressurizing tank, an external syringe type, a pump circulation supply system, and so on.

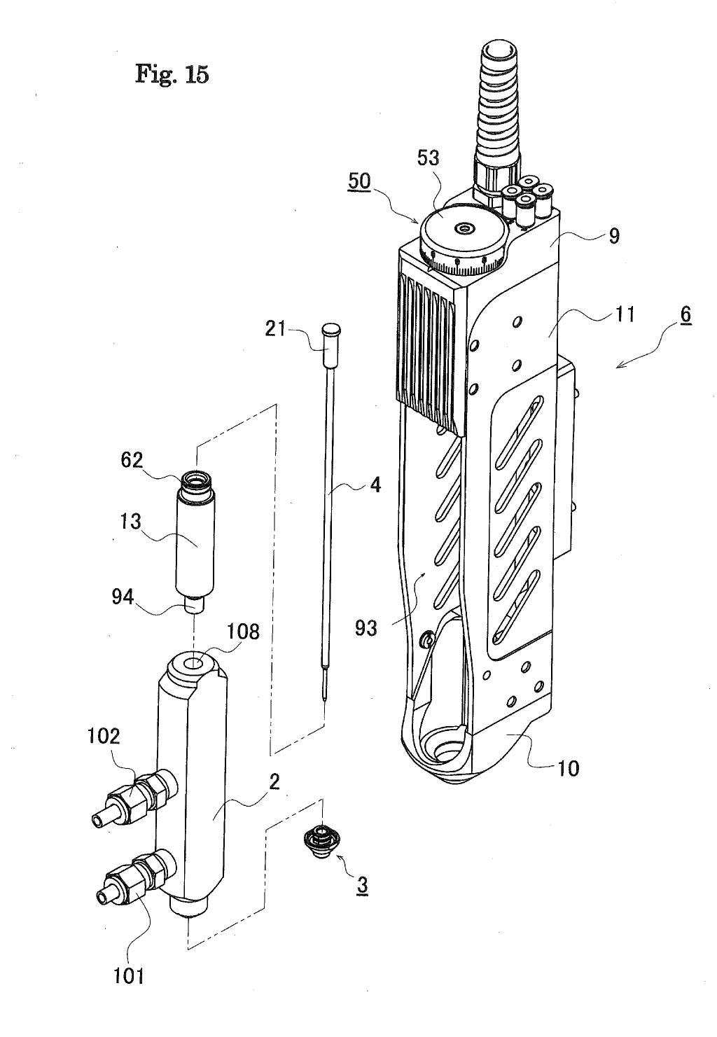

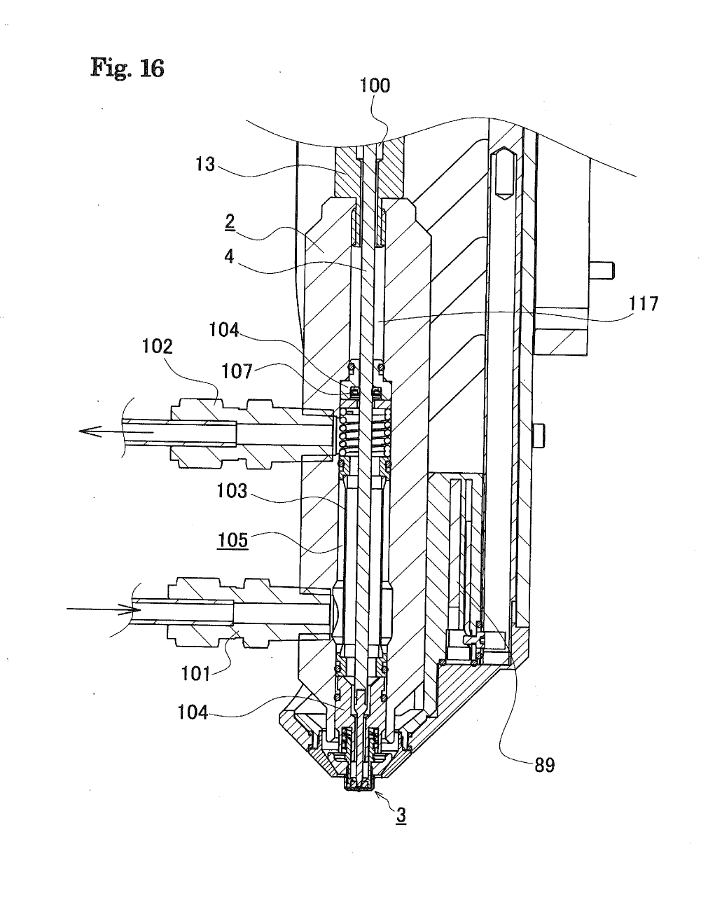

In the case of the pump circulation supply system, the valve of the present invention is mounted on a circulating passage where the liquid material is circulated by fluid pressure applied with a pump not illustrated such that a desired amount of the liquid material can be discharged by opening/closing the needle while receiving supply of the liquid material fed by pressure. In other words, the valve of the present invention can be utilized as a spray gun used for painting or the like by providing, instead of the syringe 1 of the above-described embodiment, an inlet port 101 and an outlet port 102 for the liquid material, and attaching, to the valve body 6, a functional cartridge 2 including a filter element 103 between these ports as illustrated in FIGS. 15 and 16. In the case of this pump circulation supply system, pressure is applied to the circulating liquid material itself, and therefore, it is not necessary to supply air into the functional cartridge 2 via the junction box of the valve body 6 in order to discharge the liquid material. Accordingly, as illustrated in FIG. 16, the inside of the cartridge 2 is sealed with seal plugs 104 interposing the filter element 103, and also the needle 4 is disposed in a manner passing through the seal plugs 104 while the inlet port 101 for supply and the outlet port 102 for back-flow are provided in communication with a sealed space 105 located between the seal plugs 104. With this structure, the liquid material passes and circulates inside the cartridge 2 when the liquid material is not discharged, and the liquid material passes though the filter element 103 and is injected from the valve seat 46 when the liquid material is discharged. Here, same as positioning for the syringe 1, flushing air is applied to the positioning member 14 to move down the same, and pushes the functional cartridge 2 to a predetermined position. After that, the air pressure is also kept applied to the upper portion of the functional cartridge 2 via the junction box 9 and the extension rod 13 of the valve body 6 to such a degree to discharge the liquid material. By this, the functional cartridge 2 is held at the predetermined position and further a pressure difference from the sealed space 105 inside the functional cartridge can be eliminated. In this case, movement of the needle 4 can be made smooth because a U packing 107 of the seal plug 104 which strains the needle 4 is prevented from being expanded due to pressure difference. In the case of the pump circulation supply system, the heater 89 and a filter can be included in the valve body 6 and a functional module. Therefore, the heater 89 and the filter can be excluded from the circulation system for simplification. In other words, in the case of use in which only a small amount of expensive liquid material is applied, the heater and the filter device are not necessary to be disposed on a circulation path. Therefore, pump circulation can be executed with a minimum amount of the liquid material inside a liquid circuit because abundant capacity of the liquid material required to fill these components is not needed. Meanwhile, the functional cartridge 2 can be attached to the valve body 6 via the extension rod 13, but the functional cartridge 2 may be directly attached to the valve body 6 by making a length of the cartridge itself to a length not requiring the extension rod 13. In this case, a rear end of the functional cartridge 2 is formed in the same size and shape of the third plug 61 of the universal adapter 12 (plug 62 of the extension rod 13), thereby directly fitting the rear end into the connecting port 60 of the positioning member 14.

Further, the extension rod 13 and the functional cartridge 2 are connected by fitting the plug portion 94 at the lower end of the extension rod 13 into a hole 108 opened at an upper end of the functional cartridge 2. The connecting structure may be fitting by use of a screw illustrated in FIG. 16, but a method of fitting and inserting may also be adopted in which a component is inserted interposing an O-ring without forming a thread. Further, the same connecting structure is applied between the extension rod 13 and the universal adapter 12 illustrated in FIGS. 9 and 10.

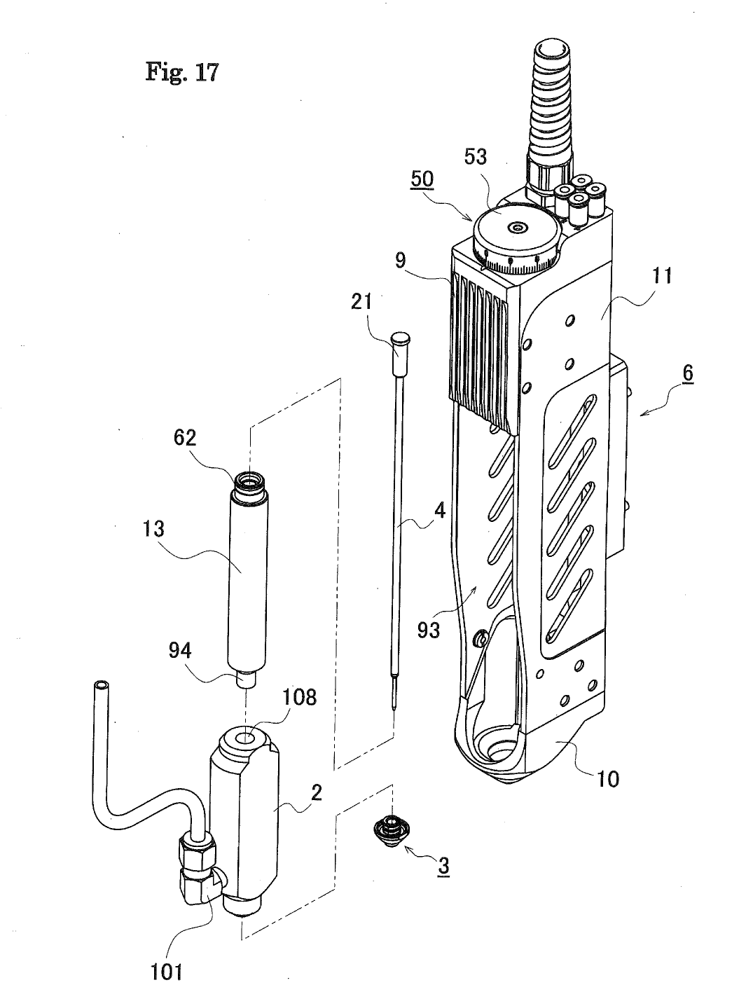

Additionally, as illustrated in FIG. 17, the valve can be applied to a system in which liquid is supplied with pressure from a pressurizing tank. The cartridge 2 in this case does not require the back-flow outlet port 102 for circulation because the pressurized liquid material is only supplied from the external pressurizing tank not illustrated.

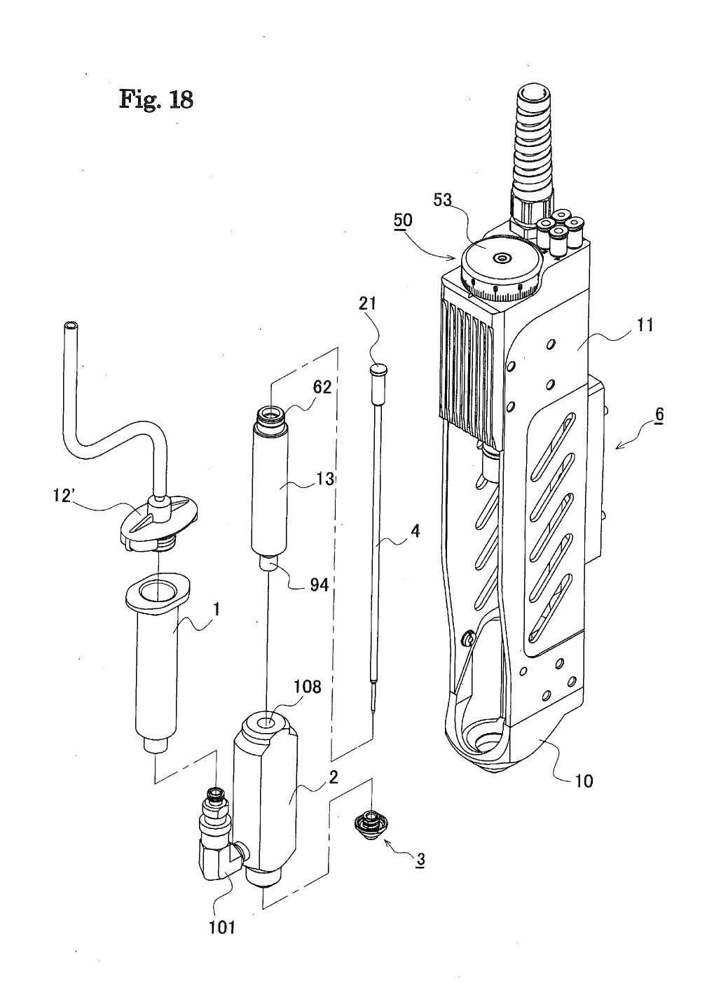

Further, as illustrated in FIG. 18, the valve can be applied as an external syringe system in which the syringe 1 is attached to the outside of the valve body 6 to receive supplied liquid material. In this case, there is no influence of the size and form of the syringe 1, and there is no restriction in a form/structure of the adapter 12′.

As described above, according to the valve of the present invention, the syringe 1 having various kinds of capacity/forms or various kinds of function module 2 can be combined, and further the syringe 1 having various lengths or the various kinds of function module 2 can be combined by utilizing the extension rod 13. Therefore, the single valve can be commonly used for the syringe and the functional module. Further, since one module preliminarily incorporating the wetted portion, namely, the syringe 1 or the functional cartridge 2, the needle 4 and the valve seat assembly 3 is formed, maintenance for the wetted portion can be simply performed.

Furthermore, in the present embodiment, the description has been given for the example in which the syringe or the functional cartridge of various sizes can be attached to only one valve body 6 by using the universal adapter 12 and the extension rod 13, but not limited thereto, a dedicated valve body 6 corresponding to each syringe size or each size and form of the functional cartridge may be prepared, and the syringe or the functional cartridge may be attached via or not via a dedicated adapter.

Moreover, in the present embodiment, the solenoid having excellent responsiveness is adopted as the actuator 5, but not limited thereto, actuators such as a hydraulic or pneumatic fluid pressure cylinder, a motor, and a diaphragm, particularly, an actuator utilizing air pressure can be also used as well. In this case, the armature 7 inside the junction box 9 may be directly driven by the actuator 5, and as the case may be, the connecting member 8 may be directly driven. For example, in the case of utilizing the diaphragm, the connecting member 8 is preliminarily fixed to the diaphragm, and vertical movement of the connecting member 8 can be controlled by changing pressure given to the diaphragm. Further, in the case of utilizing the fluid pressure cylinder, a piston itself may be applied as the connecting member 8, or the connecting member 8 may linked with the piston. That is, a part of the actuator may be provided as the driven member.

Additionally, in the above-described embodiment, the syringe 1 or the functional cartridge 2 to be inserted into the syringe housing space 93 is connected to a portion relating to connection to the valve body 6 side, namely, the connecting port 60 of the positioning member 14 via the adapter 12 or the extension rod 13, but not limited thereto, direct connection is also possible by forming the shape of the end portion of the syringe 1 or the functional cartridge 2 in a shape fittable and common with the connecting port 60. With this structure, in the case of a dedicated valve corresponding to a specific syringe 1 or functional cartridge 2, or in the case of a valve conforming to a syringe 1 or a functional cartridge 2 having a standardized opening at the upper end, the valve can be attached to any syringe 1 or any functional cartridge 2 with a fingertip operation without interposing the adapter 12 or the extension rod 13 as far as the size is containable inside the syringe housing space 93. Further, as the case may be, the connecting portion 60 at the lower end of the positioning member 14 may be formed in a plug-shaped insertion unit provided with a sealing mechanism (e.g., shape like the plug 61 of the adapter 12) so as to be directly fitted into a hole of the adapter 12 or the extension rod 13, or a hole of the syringe 1 or the functional cartridge 2.

Further, according to the above-described embodiment, the positioning member 14 is vertically moved by applying compressed air, but not limited thereto, the syringe 1 or the functional cartridge 2 may be fitted into the positioning member 14, namely, attached to the valve body 6 by directly moving the positioning member 14 in the vertical direction by the hand. For example, a handle or a lever projecting outside the junction box 9 is provided at the positioning member 14, and while gripping the handle or lever, the positioning member 14 may be advanced and retreated relative to the syringe 1 or the functional cartridge 2 housed inside the syringe housing space 93. In this case, the syringe 1 or the functional cartridge 2 pressed against the valve seat assembly 3 can be held at the predetermined position by a structure in which downward force is continuously applied by interposing an elastic member, such as a compression spring, between the positioning member 14 and the lock-up sleeve 30 or junction box 9.

1. A liquid material discharge device in which discharging liquid material filled inside a syringe or supplied via a functional cartridge is controlled by opening and closing a needle valve by an actuator under an applied working gas, the liquid material discharge device comprising:
a valve seat assembly attached to a tip of the syringe or the functional cartridge;
a needle inserted into the syringe or the functional cartridge and constituting the needle valve in a space with the valve seat assembly; and
a valve body including a syringe housing space to house the syringe or the functional cartridge attached with the valve seat assembly and the needle, and further the valve body including:
the actuator,
a driven member formed separately or integrally with the actuator, driven by the actuator, and magnetically coupled to the needle, and
a positioning member configured to connect the syringe or the functional cartridge by advancing and retreating the driven member relative to the syringe or the functional cartridge, and also configured to bias the syringe or the functional cartridge toward a predetermined position,
wherein the syringe or the functional cartridge inserted with the needle and attached with the valve seat assembly can be removably attached to the valve body by magnetically coupling the needle inserted inside the syringe or the functional cartridge to the driven member inside the valve body.

2. The liquid material discharge device according to claim 1, wherein
the valve body includes at least a junction box, a nozzle base configured to receive and hold the valve seat assembly, and a platform configured to connect the junction box to the nozzle base and define and form the syringe housing space between the nozzle base and the junction box, and
the actuator, the driven member, and the positioning member are included in the junction box, and a passage to supply the working gas supplied via the junction box to the syringe or the functional cartridge is established by the positioning member being connected to the syringe or the functional cartridge.

3. The liquid material discharge device according to claim 1, wherein the actuator is a solenoid, an armature and a connecting member are included in the valve body as the driven members together with the actuator, and are disposed such that movement of the armature attracted by exciting the solenoid is transmitted to the needle via the connecting member.

4. The liquid material discharge device according to claim 3, wherein the armature and the connecting member are separable different structures, and further clearance in an axial direction is set between the armature located at a standby position and the connecting member located at a home position, and when the armature is driven by the actuator, only the armature is moved and the connecting member is not moved until the clearance is closed, and after the clearance is closed, the armature works with the connecting member to move the needle together.

5. The liquid material discharge device according to claim 3, wherein the armature and the connecting member are integrated, and the armature and the connecting member are constantly moved integrally.

6. The liquid material discharge device according to claim 1, wherein the positioning member is configured to
include, at a lower portion, a connecting portion to be fitted into the syringe or the functional cartridge,
function as a connection mechanism capable of performing centering and connection of the syringe or the functional cartridge by being fitted into the syringe or the functional cartridge when the positioning member is moved down, and
function as a mechanism to facilitate removal of the syringe or the functional cartridge inserted with the needle by the positioning member being moved up to an upper limit of a movable range and then being separated from the syringe or the functional cartridge, and further by pushing up the driven member to make clearance between the driven member and the syringe or the functional cartridge.

7. The liquid material discharge device according to claim 2, wherein the platform is formed to have a U-shaped cross section and surrounds three surfaces on both right and left sides and back surface except for a front surface side at which the syringe or the functional cartridge is inserted and ejected.

8. The liquid material discharge device according to claim 7, wherein the syringe or the functional cartridge is housed without being tilted in a horizontal direction by setting a distance between both right and left side walls slightly larger than a maximum diameter portion on the syringe side or the functional cartridge side.

9. The liquid material discharge device according to claim 8, wherein windows through which the syringe or the functional cartridge can be seen are provided at the both right and left side walls of the platform, and an ejection rod passing through the syringe housing space is placed via the windows, in which the syringe or the functional cartridge inside the syringe housing space can be ejected by moving the ejection rod toward the front face side along the windows.

10. The liquid material discharge device according to claim 3, wherein a magnet configured to attract the armature is disposed on a surface facing the actuator interposing the armature inside the valve body, and the armature is returned to a standby position not only by the armature's own weight but also by being attracted with magnetic force.

11. The liquid material discharge device according to claim 1, wherein the valve body includes, in a manner independent from each other, a valve stroke adjustment mechanism configured to control a rising end of the needle, and a biasing mechanism configured to constantly apply biasing force to push back the needle to a home position, and a stroke amount of the needle can be adjusted under a constant biasing force.

12. The liquid material discharge device according to claim 11, wherein a length of a space to house the biasing mechanism configured to push back the needle to the home position can be changed, and biasing force of the biasing mechanism can be adjusted in a stepless manner.

13. The liquid material discharge device according to claim 11, wherein a collar is housed in a top portion of a space to house the biasing mechanism, and biasing force of the biasing mechanism can be adjusted by changing an effective length of the space to house the biasing mechanism by changing the collar with another collar having a different height.

14. The liquid material discharge device according to claim 11, wherein the biasing mechanism is formed of a plurality of magnets, and the magnets are disposed such that the same polarities are opposed to each other.

15. The liquid material discharge device according to claim 1, wherein an upper end surface of the top portion of the needle is formed in a spherical surface.

16. The liquid material discharge device according to claim 1, having a structure where the syringe or the functional cartridge in which fastening of the valve seat assembly is insufficient cannot be inserted into the syringe housing space because an axial-direction effective length of the syringe housing space is set longer than an entire length of the syringe or the functional cartridge when the valve seat assembly and the needle are set in home positions, and further the axial-direction effective length of the syringe housing space is set shorter than a length when clearance is made in a degree that leakage of liquid material inside is caused due to fastening of the valve seat assembly attached to a tip of the syringe or the functional cartridge.

17. The liquid material discharge device according to claim 1, wherein
the valve body includes the syringe housing space having a size possible to house the syringe or the functional cartridge having maximum capacity assumed to be used, and the valve body can be attached with the syringe or the functional cartridge of various sizes which can be housed inside the syringe housing space by adjusting a length of the syringe or a length of the functional cartridge by using one or both of a universal type adapter and a plurality of extension rods having different lengths which can be connected to the syringe or the functional cartridge of a plurality of sizes,
the adapter is formed as one integrated block including, at an upper end, a plug portion to be connected to the positioning member and, at a different place, a plug portion having a shape conforming to an opening of the syringe or the functional cartridge to be connected, and further the adapter includes a hole configured to pass the needle through centers of the respective plug portions and enable the extension rod to be interposed, and
the extension rod includes an upper end plug portion to be connected to the positioning member and a lower end plug portion to be directly connected to the adapter, or to the corresponding syringe or the functional cartridge.

18. The liquid material discharge device according to claim 17, wherein a guide portion is provided on the valve body side, and positioning on a back side can be controlled by making the guide portion abut against a portion adjacent to the plug portion of the adapter or the extension rod to be connected to the positioning member.

19. The liquid material discharge device according to claim 11, wherein the valve stroke adjustment mechanism is provided with a torque limiter, and a zero point can be correctly achieved by idling the valve stroke adjustment mechanism when torque of a setting value or a higher value is applied to the valve stroke adjustment mechanism.

20. The liquid material discharge device according to claim 2, wherein
a lock-up sleeve to be housed in an inner space of the junction box is provided,
the connecting member and the positioning member are housed inside the lock-up sleeve and then housed inside the junction box,
the lock-up sleeve includes a dowel which projects from a peripheral surface of the lock-up sleeve,
a dowel hole and an L-shaped guide groove are provided on an inner peripheral wall surface defining the inner space of the junction box configured to house the lock-up sleeve, the L-shaped guide groove is formed of a horizontal groove formed in a circumferential direction and connected to the dowel hole, and a vertical groove formed in an axial direction and extending to an opening of the junction box,
the lock-up sleeve and the junction box are integrally formed by passing the dowel through the guide groove and fitting the dowel into the dowel hole located at an end of the guide groove, and
the lock-up sleeve has a structure in which the lock-up sleeve can be attached or removed together with the driven member and the positioning member by applying flushing air to push the syringe to a predetermined position in a state that the dowel is released from the dowel hole and positioned at the vertical groove by rotating the lock-up sleeve in a circumferential direction.
